(19) United States
(12) Patent Application Publication
(10) Pub. No.: US 2026/0180676 A1
(43) Pub. Date: Jun. 25, 2026

(54) METHODS AND SYSTEMS FOR PROVIDING PDN CONNECTIVITY IN S&F

(71) Applicant: SAMSUNG ELECTRONICS CO., LTD., Suwon-si (KR)

(72) Inventors: Lalith KUMAR, Bangalore (IN); Utsav SINHA, Bangalore (IN); Aman AGARWAL, Bangalore (IN); Sidhant JAIN, Bangalore (IN); Dinesh Rooparam CHOUDHARY, Bangalore (IN); Vishal YADAV, Bangalore (IN)

(21) Appl. No.: 19/427,330

(22) Filed: Dec. 19, 2025

Related U.S. Application Data
(63) Continuation of application No. PCT/KR2025/022165, filed on Dec. 18, 2025.

(30) Foreign Application Priority Data
Dec. 20, 2024 (IN) 202441085275
Dec. 9, 2025 (IN) 202441085275

(51) Int. Cl. H04B 7/185; H04W 8/04; H04W 8/20

(52) U.S. Cl. CPC H04B 7/18541; H04B 7/18589; H04W 8/04; H04W 8/20

(57) ABSTRACT

Methods and/or systems for providing packet data network (PDN) connectivity in a satellite communication network. An example method may include storing, by a mobility management entity (MME)-onboard entity, a PDN connectivity request at a first time instance, on the MME-onboard entity receiving the PDN connectivity request from a user equipment (UE). A method may include processing, by the MME-onboard entity, a PDN connectivity procedure based on the PDN connectivity request, on the MME-onboard entity establishing a feeder link and obtaining a connection with a ground core network (CN) entity. A method may include obtaining, by the MME-onboard entity, a response corresponding to the PDN connectivity procedure from an MME-ground entity. A method may include implementing, by the MME-onboard entity, the PDN connectivity procedure based on the PDN connectivity procedure being initiated by the UE at a second time instance.

### CROSS REFERENCE TO RELATED APPLICATIONS

This application is based on and derives the benefit of each of PCT/KR 2025/022165, filed Dec. 18, 2025, Indian Provisional Application 202441085275 filed Dec. 20, 2024, and Indian Patent Application 202441085275 filed Dec. 9, 2025, the contents of which are all hereby incorporated herein by reference.

### TECHNICAL FIELD

Certain example embodiments may relate to wireless communication networks, and for example to managing packet data network (PDN) connectivity in store & forward (S&F) operations in wireless communication networks.

### BACKGROUND

For a fifth generation (5G) system with satellite access, the following typically apply:
The 5G system shall support service continuity between new radio (NR) terrestrial access network and NR satellite access networks owned by the same operator or owned by 2 different operators having an agreement.

The non-terrestrial network (NTN) and non-terrestrial network (TN) could either operate in two different frequency bands (e.g. FR1 vs FR2), or in the same frequency band (for example, FR1 or FR2).

The store and forward (S&F) satellite operation in a 5G system with satellite access is intended to provide some level of communication service for user equipments (UEs) under satellite coverage with intermittent/temporary satellite connectivity (for example, when the satellite is not connected via a feeder link or via inter-satellite link (ISL) to the ground network) for delay-tolerant communication service.

An example of “S&F satellite operation” is illustrated in FIG. 1A, in contrast to what could be considered the current assumption for the “normal/default Satellite operation” of a 5G system with satellite access.

As shown FIG. 1A, under “normal/default satellite operation” mode, signalling and data traffic exchange between a UE with satellite access and the remote ground network (106) requires the service and feeder links to be active simultaneously, so that, at the time that the UE interacts over the service link with the satellite (104), there is a continuous end-to-end connectivity path between the UE (102) (e.g., internet of things (IoT) device or the like), the satellite (104) and the ground network (106).

In contrast, under “S&F Satellite operation” mode, the end-to-end exchange of signalling/data traffic is now handled as a combination of two operations not concurrent in time (Step A and B in FIG. 1B). In Step A, signalling/data exchange between the UE and the satellite (104) takes place, without the satellite (104) being simultaneously connected to the ground network (e.g. the satellite (104) is able to operate the service link without an active feeder link connection). In Step B, connectivity between the satellite (104) and the ground network (106) is established so that communication between the satellite (104) and the ground network (106) can take place. So, the satellite (104) moves from being connected to the UE in step A to being connected to the ground network (106) in step B.

The support of S&F satellite operation is especially suited for the delivery of delay-tolerant/non-real-time IoT satellite services with non-geostationary orbit (NGSO) satellites.

The UE context can be at least one of the following (as depicted in FIGS. 2A-2G).

When the feeder link is not available and the UE is not registered in a current tracking area identity (TAI) or has lost the registration context/network (NW) context, it is not clear as to how the UE can trigger registration/attach.

Further, it is not clear as to how a satellite (104) (which does not have UE information/UE context/UE subscription details) will handle the attach request/registration request received from the UE.

Further, it is not clear as to how the round trip time between UE and the mobility management entity (MME) on ground will be handled when the UE is in a location where there is no terrestrial network and the satellite (104) serving the UE has no feeder link available.

Further, it is not clear as to how a UE will perform a PDN connectivity procedure (standalone or along with attach procedure) when the serving gateway (SGW), packet data network gateway (PGW) are not on the satellite (104), and the satellite (104) can communicate either with the UE or with the SGW and the PGW on the ground, needs to be clarified.

Further, it is not clear as to what changes are required in the PDN connectivity procedure or other evolved packet system session management (ESM) procedures when UE is in S&F operation mode and needs to be solved.

Hence, there is a need in the art for solutions which will overcome one or more of the above mentioned drawback(s), for example.

### SUMMARY

Certain example embodiments involve methods and/or systems for providing PDN connectivity in S&F in wireless communication networks.

Certain example embodiments involve methods and/or systems for the UE to trigger registration/attach, when the feeder link is not available and UE is not registered in current TAI or has lost the registration context/NW context.

Certain example embodiments involve methods and/or systems for a satellite (e.g., which does not have UE information/UE context/UE subscription details) to handle the attach request/registration request received from the UE.

Certain example embodiments involve methods and/or systems for handling the round trip time between the UE and the MME on ground, when the UE is in a location where there is no terrestrial network and the satellite (e.g., serving the UE) has no feeder link available.

Certain example embodiments involve methods and/or systems for a UE to perform a PDN connectivity procedure (e.g., standalone or along with attach procedure) when the SGW, PGW are not on the satellite, and the satellite can communicate either with the UE or with the SGW and the PGW on the ground.

Certain example embodiments involve changes to existing attach/registration procedures to handle the attach/registration when UE and Satellite are operating in S&F mode.

Certain example embodiments involve changes to the PDN connectivity procedure and/or other ESM procedures, when the UE is in S&F operation mode.

Certain example embodiments involve a method for providing a packet data network (PDN) connectivity in a satellite communication network. The method may include receiving, by a mobility management entity (MME)-onboard entity, a PDN connectivity request from a user equipment (UE) and storing the PDN connectivity request at a first time instance. The method may include establishing, by the MME-onboard entity, a feeder link, obtaining a connection with a ground core network (CN) entity, and processing a PDN connectivity procedure. The method may include obtaining, by the MME-onboard entity, a response/results corresponding to the PDN connectivity procedure from an MME-ground entity. Further, the method may include implementing, by the MME-onboard entity, the PDN connectivity procedure based on the PDN connectivity procedure being initiated by the UE at a second time instance.

In an example embodiment, the PDN connectivity may be provided during a store and forward (S&F) deployment mode of a satellite communication.

In an example embodiment, the ground CN entity may include at least one of: a serving gateway (S-GW) and a PDN gateway (P-GW). The first time instance is different from the second time instance.

Certain example embodiments involve a method for providing a PDN connectivity in a satellite communication network. The method may include receiving, by a mobility management entity (MME)-onboard entity, an attach request message with the ESM message container from a user equipment (UE) at a first time instance. The method may include rejecting by an MME-onboard entity, the attach request message. The method may include communicating, by the MME-onboard entity, with an MME-ground entity at a second time instance when the feeder link is available. The method may include fetching, by the MME-ground entity, at least one security credential of the UE from a home subscriber server (HSS). The method may include executing, by the MME-ground entity, a PDN connectivity procedure after interacting with a ground core network (CN) entity before at least one security procedure is executed with the UE. The method may include synchronizing, by the MME-ground entity, regarding the default PDN connection establishment procedure results with the MME-onboard entity. Further, the method may include executing, by the MME-onboard entity, the at least one security procedure so as to authenticate the UE, when the UE sends the attach request message at a third time instance when service link is established. The method may include executing, by the MME-onboard entity, the PDN connectivity procedure upon executing the at least one security procedure and providing attach accept message to the UE.

In an example embodiment, executing, by the MME-ground entity, the PDN connectivity procedure after interacting with the ground CN entity may include releasing, by the MME-ground entity, at least one old session for the PDN connectivity procedure, and establishing, by the MME-ground entity, a new session for the PDN connectivity procedure.

In an example embodiment, executing, by the MME-ground entity, the PDN connectivity procedure after interacting with the ground CN entity may include sending, by the MME-ground entity, a create session request to a serving gateway (S-GW), wherein the S-GW sends the create session request to a packet data network gateway (P-GW), and wherein the P-GW interacts with a policy and charging rules function (PCRF) entity for at least one of: an internet protocol (IP) connectivity access network (CAN) session establishment and an IP CAN session modification, and sending, by the P-GW, a create session response to the S-GW, wherein the S-GW sends the create session response to the MME-ground entity, and wherein a session related information is saved by the MME-ground entity.

In an example embodiment, the MME-ground entity may synchronize the response of the PDN connectivity procedure with the MME-onboard entity when a feeder link is still available, and wherein the MME-ground entity may indicate a S&F mode to the server to retrieve a subscription details specific to the S&F mode and indicates that the MME-ground entity is pre-fetching a subscription data without authenticating the UE.

In an example embodiment, the PDN connectivity may be provided during a store and forward (S&F) deployment mode of the satellite communication, wherein the ground CN entity may comprise at least one of: a serving gateway (S-GW) and a packet data network gateway (P-GW), and wherein the server is a home subscriber server (HSS), and the first time instance, the second time instance and the third time instance are different from each other.

Certain example embodiments may involve a method for providing a PDN connectivity in a satellite communication. The method may include fetching, by an MME-ground entity, at least one security credential of a user equipment (UE) from a server, wherein the MME-ground entity communicates with an MME-onboard entity. The method may include executing, by the MME-ground entity, a PDN connectivity procedure after interacting with a ground core network (CN) entity before at least one security procedure is executed for the UE. Further, the method may include synchronizing, by the MME-ground entity, a response of the PDN connectivity procedure with the MME-onboard entity.

In an example embodiment, executing, by the MME-ground entity, the PDN connectivity procedure after interacting with the ground CN entity may include deleting/releasing, by the MME-ground entity, at least one old session for the PDN connectivity procedure, and creating, by the MME-ground entity, a new session for the PDN connectivity procedure.

In an example embodiment, executing, by the MME-ground entity, the PDN connectivity procedure after interacting with the ground CN entity may include sending, by the MME-ground entity, a create session request to the S-GW, wherein the S-GW sends the create session request to the P-GW, and wherein the P-GW interacts with a policy and charging rules function (PCRF) entity for at least one of: an IP CAN session establishment and an IP CAN session modification, and sending, by the P-GW, a create session response to the S-GW, wherein the S-GW sends the create session response to the MME-ground entity, and wherein a session related information is saved by the MME-ground entity.

Certain example embodiments herein may involve an MME-onboard entity that may include a PDN connectivity controller coupled directly or indirectly with a processor (comprising processing circuitry) and a memory. The PDN connectivity controller, comprising processing circuitry, may be configured to store a PDN connectivity request at a first time instance on the MME-onboard entity receiving the PDN connectivity request from a UE. The PDN connectivity controller may be configured to process a PDN connectivity procedure based on the PDN connectivity request on the MME-onboard entity establishing a feeder link and obtaining a connection with a ground core network (CN) entity. The PDN connectivity controller may be configured to obtain a response corresponding to the PDN connectivity procedure from an MME-ground entity. The PDN connectivity controller may be configured to complete the PDN connectivity procedure during an attach procedure with when the procedure is initiated by the UE at a second time instance.

Certain example embodiments may involve an MME-ground entity including at least one processor (comprising processing circuitry) and memory storing instructions. The instructions, when executed by the at least one processor, may cause the MME-ground entity to fetch at least one security credential of a user equipment (UE) from a server, wherein the MME-ground entity communicates with an MME-onboard entity. The PDN connectivity controller may be configured to execute a PDN connectivity procedure after interacting with a ground core network (CN) entity before at least one security procedure is executed for the UE. The PDN connectivity controller may be configured to synchronize a response of the PDN connectivity procedure with the MME-onboard entity.

Certain example embodiments may involve a satellite communication network including an MME-onboard entity, an MME-ground entity, and a ground CN entity. The MME-onboard entity may be configured to receive an attach request message with an ESM message container from a UE a first time instance. The MME-onboard entity may be configured to reject the attach request message. The MME-onboard entity may be configured to communicate with the MME-ground entity at a second time instance when the feeder link is available. The MME-ground entity may be configured to fetch at least one security credential of the UE from an HSS. The MME-ground entity may be configured to execute a PDN connectivity procedure after interacting with a ground core network (CN) entity before at least one security procedure is executed with the UE. The MME-ground entity may be configured to synchronize a response of the PDN connectivity procedure with the MME-onboard entity. The MME-onboard entity may be configured to execute the at least one security procedure so as to authenticate the UE, when the UE sends the attach request message at a third time instance when a service link is established. The MME-onboard entity may be configured to execute the PDN connectivity procedure upon executing the at least one security procedure and provide an attach accept message to the UE.

These and other aspects of the embodiments herein will be better appreciated and understood when considered in conjunction with the following description and the accompanying drawings. It should be understood, however, that the following descriptions, while indicating at least one embodiment and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF FIGURES

Certain example embodiments are illustrated in the accompanying drawings, throughout which like reference letters indicate corresponding parts in the various figures. The embodiments herein will be better understood from the following description with reference to the following illustratory drawings. Embodiments herein are illustrated by way of examples in the accompanying drawings, and in which:

FIGS. 1A and 1B depict example S&F operations, according to existing arts;

FIGS. 2A-2G depict examples of the UE context, according to existing arts;

FIG. 3A and FIG. 3B depicts the PDN connectivity procedure, according to certain example embodiments;

FIG. 4A and FIG. 4B depicts the PDN connectivity procedure, according to certain example embodiments;

FIG. 5 depicts the attach procedure with PDN Connectivity, according to certain example embodiments;

FIG. 6 depicts another attach procedure with PDN Connectivity, according to certain example embodiments;

FIG. 7A-7B and FIG. 8 are example scenario(s) in which the satellite communication network provides the PDN connectivity, according to certain example embodiments;

FIG. 9 shows various hardware components of the MME-onboard entity, according to the certain example embodiments;

FIG. 10 shows various hardware components of the MME-ground entity, according to the certain example embodiments;

FIG. 11 is a flow chart illustrating a method for providing the PDN connectivity in the satellite communication network by the MME-onboard entity, according to the certain example embodiments;

FIG. 12 is a flow chart illustrating a method for providing a PDN connectivity in a satellite communication by the MME-ground entity, according to the certain example embodiments; and

FIG. 13 is a flow chart illustrating method for providing a PDN connectivity in the satellite communication network according to the certain example embodiments.

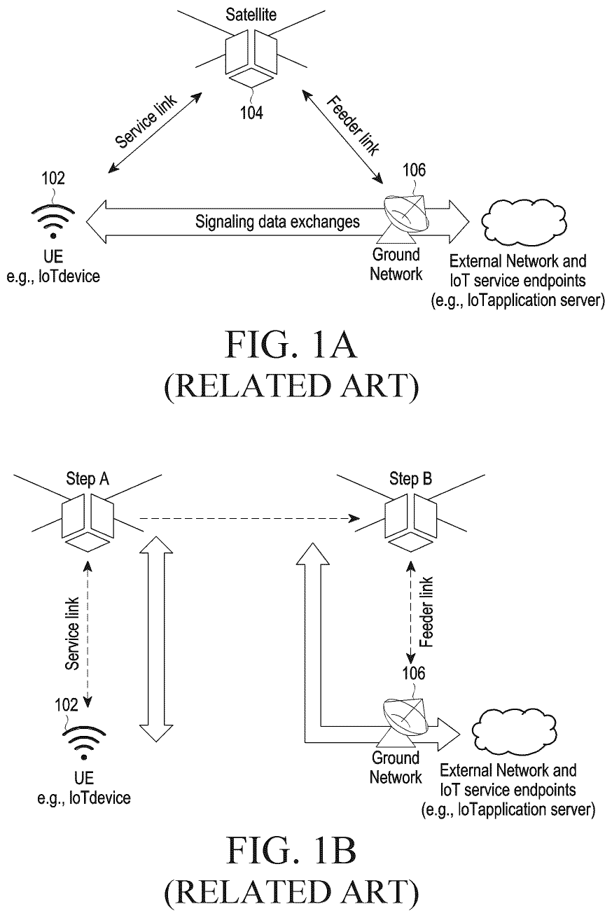

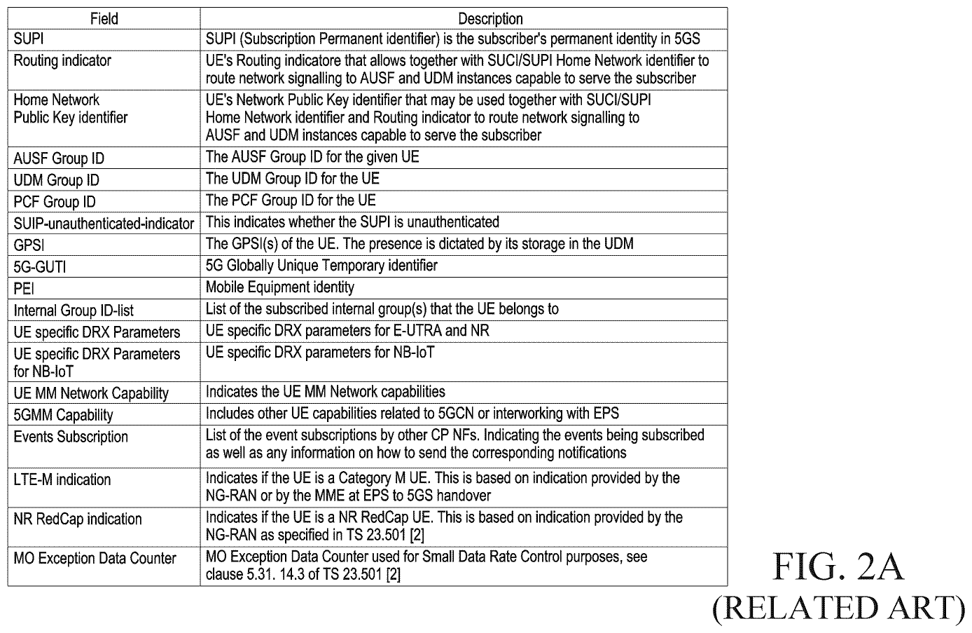

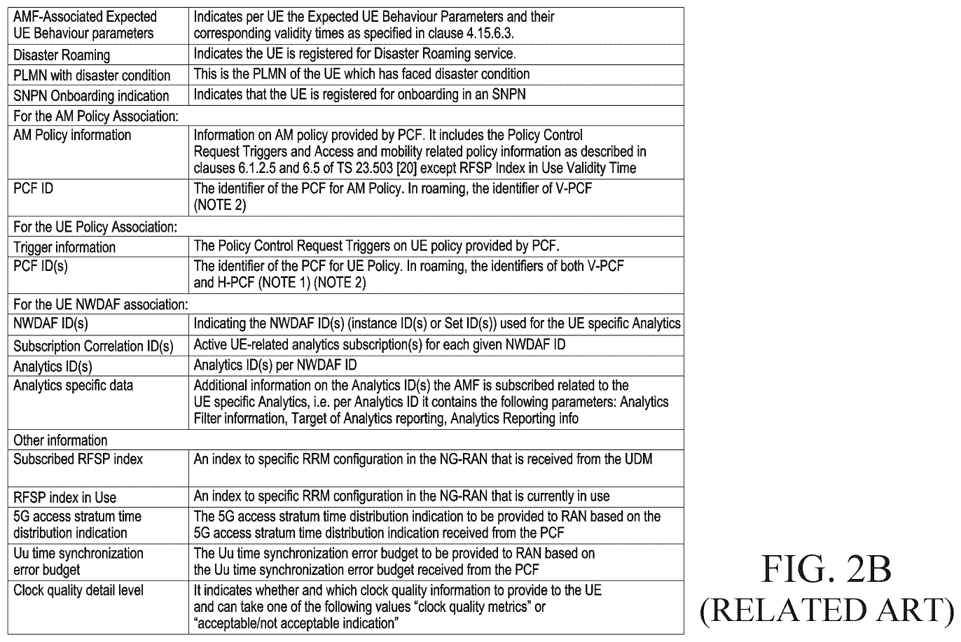

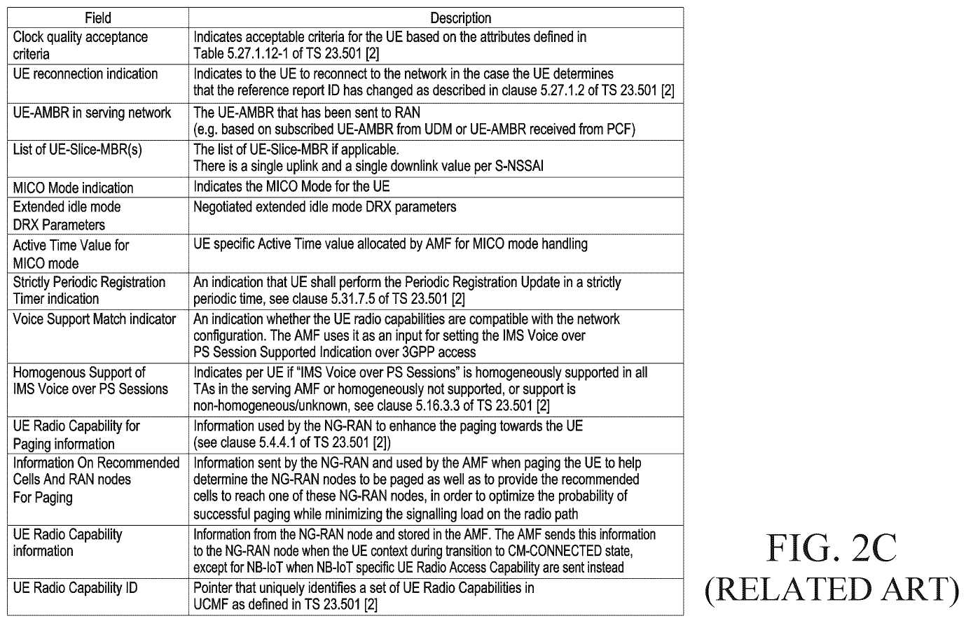

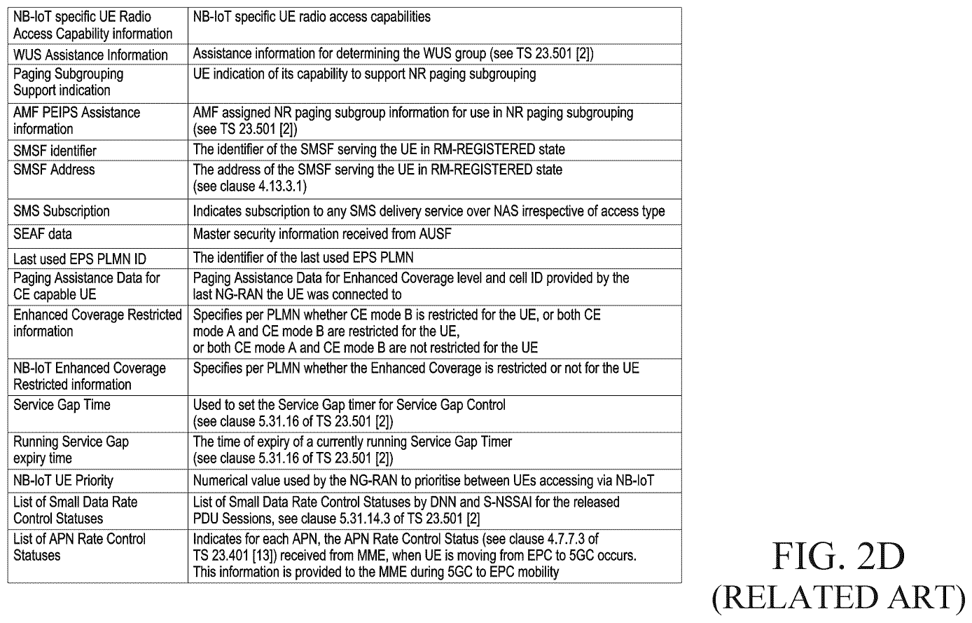

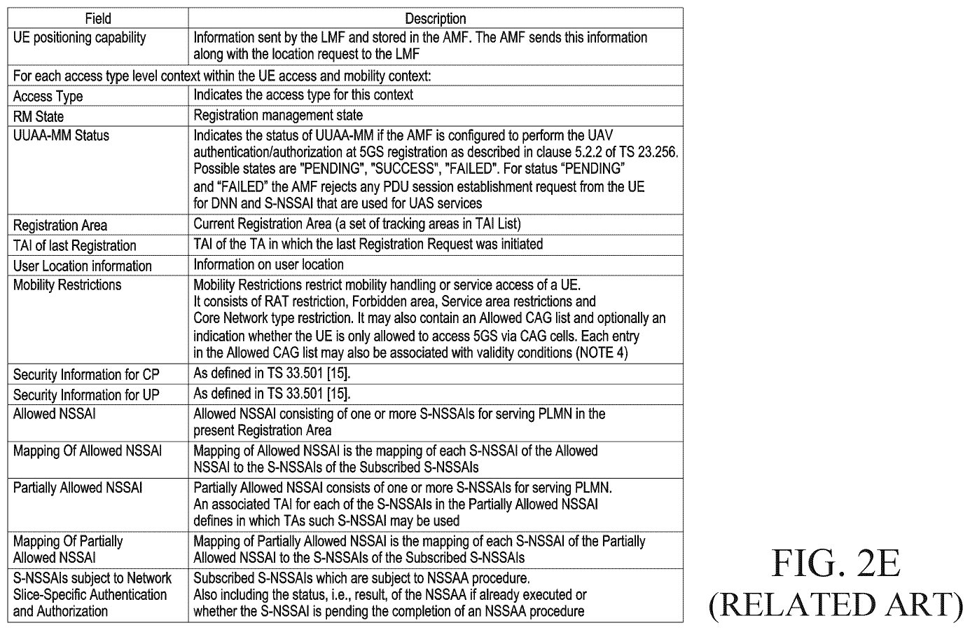

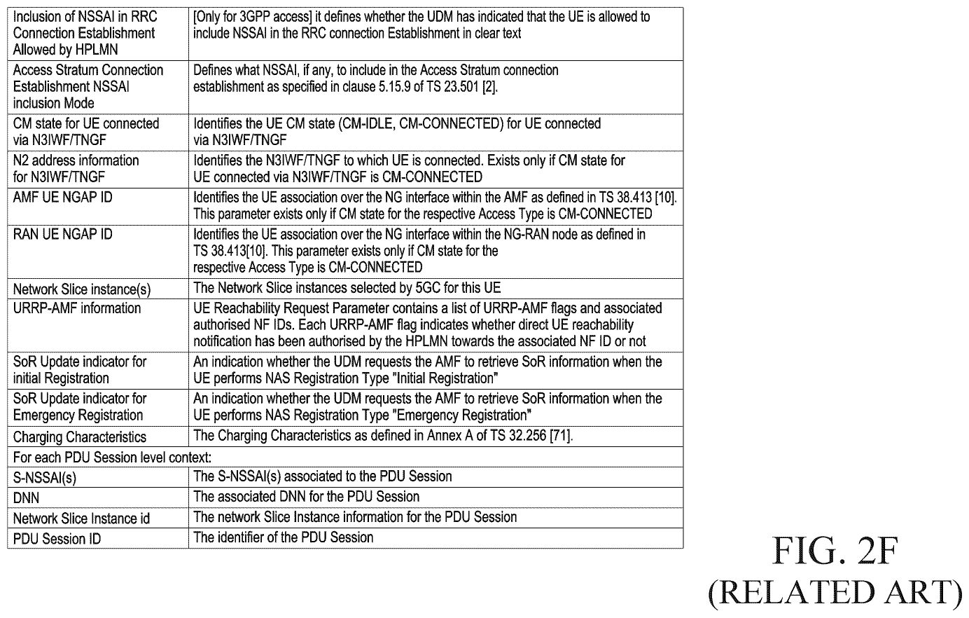

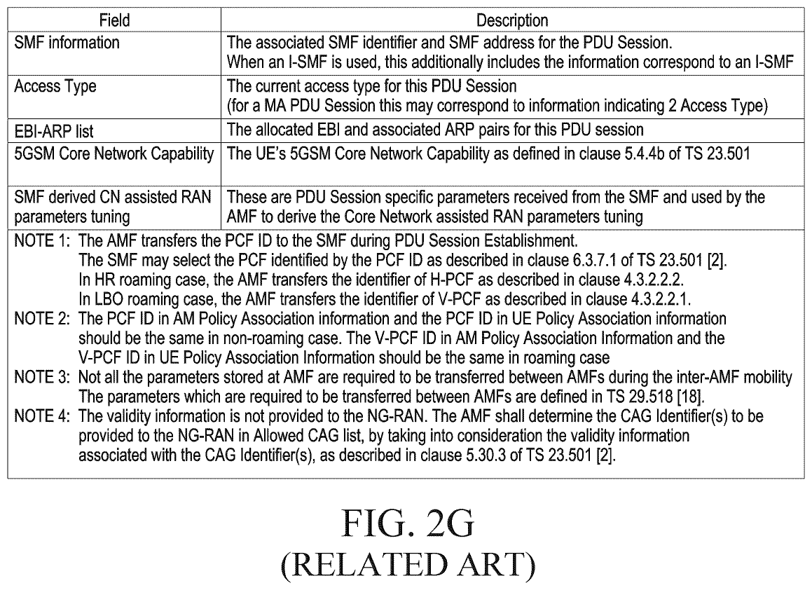

### DETAILED DESCRIPTION

Certain example embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The words/phrases “exemplary”, “example”, “illustration”, “in an instance”, “and the like”, “and so on”, “etc.”, “etcetera”, “e.g.,”, “i.e.,” are merely used herein to mean “serving” as an example, instance, or illustration. Any embodiment described herein using the words/phrases “exemplary”, “example”, “illustration”, “in an instance”, “and the like”, “and so on”, “etc.”, “etcetera”, “e.g.,” “i.e.,” is not necessarily to be construed as preferred or advantageous over other embodiments.

Embodiments herein may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by a firmware. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

It should be noted that elements in the drawings are illustrated for the purposes of this description and ease of understanding and may not have necessarily been drawn to scale. For example, the flowcharts/sequence diagrams illustrate the method in terms of the steps required for understanding of aspects of the embodiments as disclosed herein. Furthermore, in terms of the construction of the device, one or more components of the device may have been represented in the drawings by conventional symbols, and the drawings may show only those specific details that are pertinent to understanding the embodiments so as not to obscure the drawings with details that will be readily apparent to those of ordinary skill in the art having the benefit of the description herein. Furthermore, in terms of the system, one or more components/modules which comprise the system may have been represented in the drawings by conventional symbols, and the drawings may show only those specific details that are pertinent to understanding the embodiments so as not to obscure the drawings with details that will be readily apparent to those of ordinary skill in the art having the benefit of the description herein.

The accompanying drawings are used to help easily understand various technical features and it should be understood that the embodiments presented herein are not limited by the accompanying drawings. As such, the disclosure should be construed to extend to any modifications, equivalents, and substitutes in addition to those which are particularly set out in the accompanying drawings and the corresponding description. Usage of words such as first, second, third etc., to describe components/elements/steps is for the purposes of this description and should not be construed as sequential ordering/placement/occurrence unless specified otherwise.

The embodiments herein achieve methods and systems for providing sPDN connectivity in S&F in wireless communication networks.

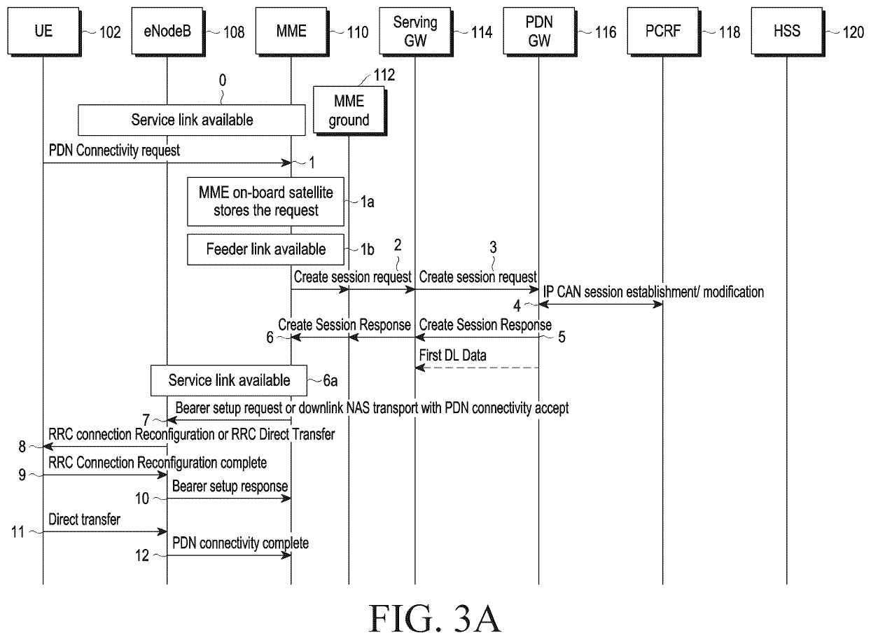

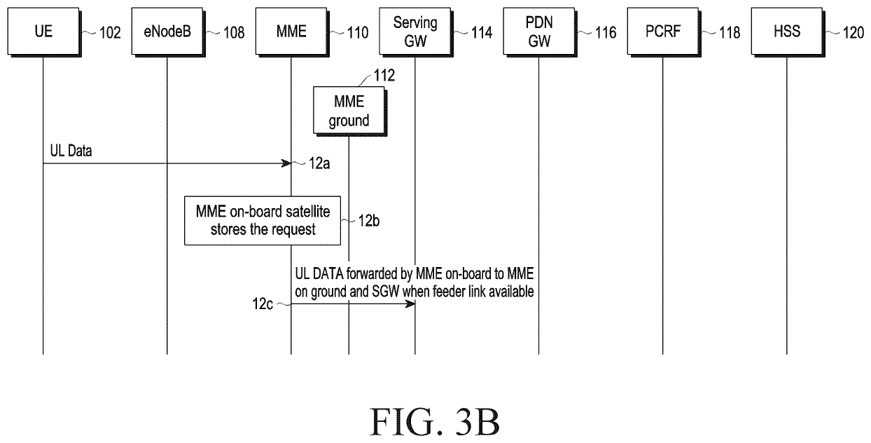

Referring now to the drawings, and more particularly to FIGS. 3A through 13, where similar reference characters denote corresponding features consistently throughout the figures, there are shown at least one embodiment.

The following definitions and abbreviations have been disclosed herein:
3GPP: Third Generation Partnership Project
4G-GUTI: 4G-Globally Unique Temporary Identifier
5G-BRG: 5G Broadband Residential Gateway
5GC: 5G Core
5GCN: 5G Core Network
5G-CRG: 5G Cable Residential Gateway
5G-GUTI: 5G-Globally Unique Temporary Identifier
5GMM: 5G Mobility Management
5G-RG: 5G Residential Gateway
5GS: 5G System
5GSM: 5GS Session Management
5G-S-TMSI: 5G S-Temporary Mobile Subscription Identifier
5G-TMSI: 5G Temporary Mobile Subscription Identifier
5QI: 5G QoS Identifier
ACS: Auto-Configuration Server
AKA: Authentication and Key Agreement
A-KID: AKMA Key Identifier
AKMA: Authentication and Key Management for Applications
AMBR: Aggregate Maximum Bit Rate
AMF: Access and Mobility Management Function
APN: Access Point Name
ARP: Allocation and Retention Policy
AS: Access Stratum
A-TID: AKMA Temporary Identifier
ATSSS: Access Traffic Steering, Switching and Splitting
AUSF: Authentication Server Function
CAG: Closed access group
CAG ID: Closed Access Group Identifier
CHAP: Challenge Handshake Authentication Protocol
CU: Centralized Unit
DC: Discontinuous Coverage
DisCo: Discontinuous Coverage
DL: Downlink
Dnd: Do Not Disturb
DRX: Discontinuous Reception
DU: Distributed Unit
eDRX: Extended Discontinuous Reception
EHPLMN: Equivalent Home Public Land Mobile Network
EMM: EUTRA Mobility Management
eNB: Evolved Node-B
eNPN: Enhanced Non-Public Networks
Epc: Evolved Packet Core
EPLMN: Equivalent Public Land Mobile Network
EPS: Evolved Packet System
eSIM: embedded Subscriber Identity Module
E-UTRA: Evolved Universal Mobile Telecommunication Access
EUTRAN: Evolved Universal Mobile Telecommunication Access Network
FPLMN: Forbidden Public Land Mobile Network
FR: Frequency Range
GEO: Geostationary Orbit
GERAN: GSM Edge Radio Access Network
GERAN EC-GSM-IoT: GSM Edge Radio Access Network Extended Coverage -
GSM-Internet of Things
gNB: Next generation Node-B
gNB-CU: Next generation Node-B Control Unit
gNB-DU: Next generation Node-B Distributive Unit
GPRS: General Packet Radio Service
GPS: Global Positioning System
GSM: Global System for Mobile Communication
HPLMN: Home Public Land Mobile Network
IAB: Integrated access and backhaul
IAB-UE: The part of the IAB node that supports the Uu interface towards the IAB-donor or another parent IAB-node (and thus manages the backhaul connectivity with either PLMN or SNPN it is registered with) is referred to as an IAB-UE.
LADN: Local Area Data Network
LCS: Location services
LEO: Low Earth Orbit
MBSR: Mobile Base Station Relay
MCC: Mobile Country Code
MCS: Mission Critical Service
ME: Mobile Equipment
MEC: Multi-Access Edge Computing
MEO: Medium Earth Orbit
MICO: Mobile Initiated Communication Only
MINT: Minimization of service interruption
MME: Mobility Management Entity
MNC: Mobile Network Code
MPS: Multimedia Priority Service
MS: Mobile Station. The document makes no distinction between MS and UE.
NAS: Non-Access Stratum
NB-S1 Mode: Narrow Band with S1 Interface
NGAP: Next Generation Application Protocol
NG-RAN: Next Generation Radio Access Network
NPN: Non-Public Networks
NR: New Radio
NTN: Non Terrestrial Networks
NW: Network
OOS: Out of Service
OS Upgrade: Operating System Upgrade
PDN: Packet Data Network
PDU: Packet Data Unit
PLMN ID: Public Land Mobile Network Identity
PSM: Power Saving Mode
QoS: Quality of Service
RAT: Radio Access Technology
RPLMN: Registered Public Land Mobile Network
RRC: Radio Resource Control
RU: Registration Update
SAT: Satellite
Satellite: An artificial body placed in orbit round the earth or moon or another planet in order to collect information or for communication.
Satellite Constellation: A group of satellites, placed in orbit round the earth or moon or another planet in order to collect information or for communication.
Service User: An individual who has received a priority level assignment from a regional/national authority (e.g., an agency authorised to issue priority assignments) and has a subscription to a mobile network operator
SIM: Subscriber Identity Module
SNPN: Standalone Non-Public Networks
SUCI: Subscription Concealed Identifier
SW: Software
TAC: Tracking Area Code
TAI: Tracking Area Identity
TAU: Tracking Area Update
TER: Terrestrial
TN: Terrestrial Networks
UCU: UE Configuration Update
UDM: Unified Data Management Function
UE: User Equipment
UL: Uplink
ULI: User Location Information
UPU: UE Parameters Update
USIM: Universal Subscriber Identification Module
Uu: The radio interface between the UE and the Node B
VMR: Vehicle Mounted Relay
VPLMN: Visited Public Land Mobile Network
WB-S1 Mode: Wide Band with S1 Interface
Visited PLMN (VPLMN): This is a PLMN different from the HPLMN (if the EHPLMN list is not present or is empty) or different from an EHPLMN (if the EHPLMN list is present).
Allowable PLMN: In the case of an MS operating in MS operation mode A or B, this is a PLMN which is not in the list of “forbidden PLMNs” in the MS. In the case of an MS operating in MS operation mode C or an MS not supporting A/Gb mode and not supporting Iu mode, this is a PLMN which is not in the list of “forbidden PLMNs” and not in the list of “forbidden PLMNs for GPRS service” in the MS.
Available PLMN: PLMN(s) in the given area which is/are broadcasting capability to provide wireless communication services to the UE.
Camped on a cell: The MS (ME if there is no SIM) has completed the cell selection/reselection process and has chosen a cell from which it plans to receive all available services. Note that the services may be limited, and that the PLMN or the SNPN may not be aware of the existence of the MS (ME) within the chosen cell.
EHPLMN: Any of the PLMN entries contained in the Equivalent HPLMN list.
Equivalent HPLMN list: To allow provision for multiple HPLMN codes, PLMN codes that are present within this list shall replace the HPLMN code derived from the IMSI for PLMN selection purposes. This list is stored on the USIM and is known as the EHPLMN list. The EHPLMN list may also contain the HPLMN code derived from the IMSI. If the HPLMN code derived from the IMSI is not present in the EHPLMN list it shall be treated as a Visited PLMN for PLMN selection purposes.
Home PLMN: This is a PLMN where the MCC and MNC of the PLMN identity match the MCC and MNC of the IMSI.
Registered PLMN (RPLMN): This is the PLMN on which certain LR(location registration which is also called as registration procedure) outcomes have occurred. In a shared network the RPLMN is the PLMN defined by the PLMN identity of the CN operator that has accepted the LR.
Registration: This is the process of camping on a cell of the PLMN or the SNPN and doing any necessary LRs.
UPLMN: PLMN/access technology combination in the “User Controlled PLMN Selector with Access Technology” data file in the SIM (in priority order).
OPLMN: PLMN/access technology combination in the “Operator Controlled PLMN Selector with Access Technology” data file in the SIM (in priority order) or stored in the ME (in priority order).
Serving satellite: A satellite providing the satellite access to a UE. In the case of Non-Geostationary Satellite Orbit (NGSO), the serving satellite is always changing due to the nature of the constellation.
Store & Forward Satellite operation: In the context of this study, it is an operation mode of a 5G system with satellite-access where the 5G system may provide some level of service (in storing and forwarding the data) when satellite connectivity is intermittently/temporarily unavailable, e.g. to provide communication service for UEs under satellite coverage without a simultaneous active feeder link connection to the ground segment.
S&F data retention period: it is the data storage validity period for the 5G system with satellite access supporting store and forward operation (for example, after which undelivered data stored is being discarded).
UE-Satellite-UE Communication: For the 5G system with satellite access, it refers to the communication between UEs under the coverage of one or more serving satellites, using satellite access without going through the ground segment.

Examples of the NAS messages can be, but not limited to, REGISTRATION REQUEST message; DEREGISTRATION REQUEST message; SERVICE REQUEST message; CONTROL PLANE SERVICE REQUEST; IDENTITY REQUEST; AUTHENTICATION REQUEST; AUTHENTICATION RESULT; AUTHENTICATION REJECT; REGISTRATION REJECT; REGISTRATION ACCEPT; DEREGISTRATION ACCEPT; SERVICE REJECT; SERVICE ACCEPT; UE CONFIGURATION UPDATE command; UE PARAMETERS UPDATE command, and so on.

The term 5GMM sublayer states in this embodiment are at least one of the below:
1) 5GMM-NULL
2) 5GMM-DEREGISTERED
   a) 5GMM-DEREGISTERED.NORMAL-SERVICE
   b) 5GMM-DEREGISTERED.LIMITED-SERVICE
   c) 5GMM-DEREGISTERED.ATTEMPTING-REGISTRATION
   d) 5GMM-DEREGISTERED.PLMN-SEARCH
   e) 5GMM-DEREGISTERED.NO-SUPI
   f) 5GMM-DEREGISTERED.NO-CELL-AVAILABLE
g) 5GMM-DEREGISTERED.eCALL-INACTIVE
h) 5GMM-DEREGISTERED.INITIAL-REGISTRATION-NEEDED
3) 5GMM-REGISTERED-INITIATED
4) 5GMM-REGISTERED
   a) 5GMM-REGISTERED.NORMAL-SERVICE
   b) 5GMM-REGISTERED.NON-ALLOWED-SERVICE
   c) 5GMM-REGISTERED.ATTEMPTING-REGISTRATION-UPDATE
   d) 5GMM-REGISTERED.LIMITED-SERVICE
   e) 5GMM-REGISTERED.PLMN-SEARCH
   f) 5GMM-REGISTERED.NO-CELL-AVAILABLE
   g) 5GMM-REGISTERED.UPDATE-NEEDED
5) 5GMM-DEREGISTERED-INITIATED
6) 5GMM-SERVICE-REQUEST-INITIATED

In this embodiment herein, the term EMM sublayer states are at least one of the below:
1) EMM-NULL
2) EMM-DEREGISTERED
   a) EMM-DEREGISTERED.NORMAL-SERVICE
   b) EMM-DEREGISTERED.LIMITED-SERVICE
   c) EMM-DEREGISTERED.ATTEMPTING-TO-ATTACH
   d) EMM-DEREGISTERED.PLMN-SEARCH
   e) EMM-DEREGISTERED.NO-IMSI
   f) EMM-DEREGISTERED.ATTACH-NEEDED
   g) EMM-DEREGISTERED.NO-CELL-AVAILABLE
   h) EMM-DEREGISTERED.eCALL-INACTIVE
3) EMM-REGISTERED-INITIATED
4) EMM-REGISTERED
   a) EMM-REGISTERED.NORMAL-SERVICE
   b) EMM-REGISTERED.ATTEMPTING-TO-UPDATE
   c) EMM-REGISTERED.LIMITED-SERVICE
   d) EMM-REGISTERED.PLMN-SEARCH
   e) EMM-REGISTERED.UPDATE-NEEDED
   f) EMM-REGISTERED.NO-CELL-AVAILABLE
   g) EMM-REGISTERED.ATTEMPTING-TO-UPDATE-MM
   h) EMM-REGISTERED.IMSI-DETACH-INITIATED
5) EMM-DEREGISTERED-INITIATED
6) EMM-TRACKING-AREA-UPDATING-INITIATED
7) EMM-SERVICE-REQUEST-INITIATED

The term RAT as defined in this embodiment can be one of the following: NG-RAN, 5G, 4G, 3G, 2G, EPS, 5GS, NR, NR in unlicensed bands, NR (LEO) satellite access, NR (MEO) satellite access, NR (GEO) satellite access, NR (OTHERSAT) satellite access, NR RedCap, E-UTRA, E-UTRA in unlicensed bands, NB-IoT, WB-IoT, LTE-M,

5GS registration type can be, but not limited to, initial registration, mobility registration updating, periodic registration updating, emergency registration, SNPN onboarding registration, disaster roaming initial registration, disaster roaming mobility registration updating, and so on.

The terms satellite 3GPP access, satellite access, satellite access network, NR satellite access network, satellite NG-RAN access technology and NR satellite access have been interchangeably used and have the same meaning.

The methods, issues or solutions disclosed in this embodiment are explained using NR satellite access or satellite NG-RAN access technology as an example and are not restricted or limited to NR satellite access only. However, the solutions proposed in this embodiment are also applicable for satellite E-UTRAN access technology, narrow band (NB)-S1 mode or wide band (WB)-S1 mode via satellite E-UTRAN access and/or narrowband internet of things (NB-IOT) or wideband internet if things (WB-IOT) satellite access/architecture.

The solutions which are defined for NR(5GC) are also applicable to legacy RATs like E-UTRA/LTE and vice versa, wherein the corresponding CN entities need to be replaced by LTE entities; for example, AMF with MME, g-nodeB with e-nodeB, UDM with HSS etc. But principles of the solution remain the same. In a similar way, the solutions or proposal which are defined for LTE (EPC) are also applicable to other RAT(s) (for ex-5G or 5GC or 6GC and other RATs)

An example list of NAS messages can be, but not limited to, REGISTRATION REQUEST message; DEREGISTRATION REQUEST message; SERVICE REQUEST message; CONTROL PLANE SERVICE REQUEST; IDENTITY REQUEST; AUTHENTICATION REQUEST; AUTHENTICATION RESULT; AUTHENTICATION REJECT; REGISTRATION REJECT; DEREGISTRATION ACCEPT; SERVICE REJECT; SERVICE ACCEPT, and so on.

The network used in this embodiment is explained using any 5G core network function; for example, AMF. However, the network could be any 5G/EUTRAN core network entities like AMF/SMF/MME/UPF or the network could be any 5G/EUTRAN RAN entity like eNodeB (eNB) or gNodeB (gNB) or NG-RAN etc.

The messages used or indicated in this embodiment are shown as an example. The messages could be any signalling messages between UE and the network functions/entities or between different network functions/entities.

The term area/location/geographical area are used in this embodiment may refer to any of cell/cell ID, TAC/TAI, PLMN, MCC/MNC, latitude/longitude, CAG cell or any geographical location/coordinate.

The terms satellite or satellite network in this embodiment refers to the NF (e.g. AMF, SMF, UPF) onboard the satellite or 4G core network elements(e.g. MME, SGW, PGW) on board the satellite. The N

The methods, issues or solutions disclosed in this embodiment are explained using NR access or NG-RAN access technology as an example and is not restricted or limited to NR access only. However, the solutions proposed in this embodiment are also applicable for E-UTRAN access technology, NB-S1 mode or WB-S1 mode via E-UTRAN access and/or NB-IOT or WB-IOT access/architecture.

The solutions which are defined for NR (5GC) are also applicable to legacy RATs like E-UTRA/LTE, the corresponding CN entities needs to be replaced by LTE entities for e.g. AMF with MME, g-nodeB with e-nodeB, UDM with HSS etc. But principles of the solution remain same.

The Network used in this embodiment is explained using any 5G core network function for e.g. AMF. However, the network could be any 5G/EUTRAN core network entities like AMF/SMF/MME/UPF or the network could be any 5G/EUTRAN RAN entity like eNodeB (eNB) or gNodeB (gNB) or NG-RAN etc.

The messages used or indicated in this embodiment are shown as an example. The messages could be any signalling messages between the UE and the network functions/entities or between different network functions/entities.

The terms ‘camp’ and ‘register’ are used interchangeably and may have the same meaning.

The term area as used in this embodiment may refer to any of cell/cell ID, TAC/TAI, PLMN, MCC/MNC, latitude/longitude, any CAG/CAG identifier or any geographical location/coordinate.

For the list of possible NAS messages please refer to 3GPP TS 24.501 or 3GPP TS 24.301, for list of AS messages please refer to 3GPP TS 38.331or 3GPP TS 36.331

The cause names in this embodiment are for illustration purpose and it can have any name. The non access stratum (NAS) messages and access stratum (AS) messages described in this embodiment is for illustration purpose it can be any NAS or AS messages as per defined protocol between UE and AMF/MME or UE and gNB(NG-RAN/any RAN node)/ eNB.

In this embodiment, the term satellite is used interchangeably with 5G or 4G system or 6G system with satellite access and is used to represent any Satellite(s) or constellation of satellites(s) or any aerial body/satellite in any of the satellite orbits (for example, LEO/MEO/GEO/HEO etc.) or any 5G system with satellite access or 4G system with satellite access or any RAN entity or core network entity or any network function(s) associated with the satellite access/RAT/PLMN/network.

FIG. 3A and FIG. 3B depicts the PDN connectivity procedure. Consider that a service link is available between the UE (102) and the satellite (104). In operation 1, the UE (102) sends a PDN connectivity request message to the MME on board satellite via the eNodeB (108) on board the satellite (104). The UE (102) enters the state PROCEDURE TRANSACTION PENDING (as mentioned in section 6.5.1.2 in TS 24.301) or it can be any other state to handle the scenario discussed in this embodiment. The retry timer T3482/new timer started by UE NAS layer for this procedure is started with a value that considers the coverage information of the satellite (104), for example the time that will be taken by the satellite (104) to come back to UE's coverage after this pass.

In operation 1a, the MME on-board satellite stores this message or memorizes about this message from UE (102), till feeder link is available. In operation 1b, the feeder link becomes available. In parallel UE loses service link with the satellite (104), and as a result NAS signalling connection gets released and UE (102) goes into no service. The UE (102) does not go into the usual recovery mechanism for the PDN procedure but waits for retry till timer expiry mentioned in operation 1. The UE (102) remains in PROCEDURE TRANSACTION PENDING state for the PDN requested.

Once the feeder link is available, the MME on-board the satellite (104) executes operations 2 to 6 as described in FIG. 3, and in section 5.10.2 of TS 23.401, via MME on the ground. As part of these steps, the MME on board interacts with the MME on the ground, and the MME on the ground sends a create session request to the serving GW (114), and the serving GW (114) in turn sends the request to the PDN GW (116). The PDN GW (116) interacts with the PCRF (118) for IP CAN session establishment or modification. After executing these operations, the PDN GW (116) sends a create session response to the serving GW (114), and the serving GW (114) sends the same to the MME on the ground. The same is forwarded to the MME on board satellite, via the feeder link.

In this embodiment, the terms ‘MME onboard’, ‘MME-gnd’ and ‘MME’ are used interchangeably and indicate the MME network entity.

Once the satellite (104) comes back in coverage of the UE (102), e.g. the service link is available, in operation 6a, the MME on-board the satellite optionally pages the UE (102), and when the UE (102) is back in connected mode with the eNodeB (108) on board the satellite (104). After this point, the UE (102), the eNodeB (108) and MME on-board satellite execute operations 7 to 12. As part of these operations, the RABs are setup or the MME sends the PDN CONNECTIVITY ACCEPT or ACTIVATE DEFAULT EPS BEARER CONTEXT REQUEST message to the eNodeB (108). The PDN CONNECTIVITY ACCEPT or ACTIVATE DEFAULT EPS BEARER CONTEXT REQUEST message is further sent to the UE.

In operation 12a, the UE (102) starts sending first UL data after this operation, to the eNodeB (108) and MME on-board satellite. In operation 12b, the MME on-board satellite (104) stores the UL data till the feeder link is available. In operation 12c, the MME on-board sends the pended UL data to the MME on ground and the S-GW/P-GW (once the feeder link is available). The MMOE and eNodeB (108) are present on the satellite (104), and the MME-gnd is MME ground (112) which is present on the ground.

The MME/SGSN receives subscription information for a non-IP PDN connection to an APN that is associated with an “Invoke SCEF Selection” indicator, and SCEF ID. If the MSISDN is also associated with the user's subscription, it is made available as a user identity to the MME/SGSN by the HSS (120). If the subscription information corresponding to either the default APN for PDN type of “Non-IP” or the UE requested APN includes “Invoke SCEF Selection” indicator, the MME/SGSN shall create a PDN connection towards the SCEF and allocate an EPS bearer identity (EBI) (see TS 23.401) to that PDN connection. The MME/SGSN does so by sending a create SCEF connection request (user identity, EPS bearer identity, SCEF ID, APN, serving PLMN rate control, PCO, serving PLMN ID, IMEISV) message towards the SCEF (see clause 4.7.7 of TS 23.401). If the IWK-SCEF receives the create SCEF connection request message from the MME/SGSN, it shall forward it to the SCEF.

In this embodiment herein, the interaction of the MME is shown with the S-GW as an illustration, however it may be obvious to a person of ordinary skill in the art that it can be on similar lines with the SCEF to establish the PDN connection.

In summary, the UE (102) initiates the PDN connectivity procedure and sends the ESM message to the network, the network is not able to handle this procedure and at some point, the RRC connection or NAS signalling connection is released from the network, the UE (102) may be released to IDLE state or the suspended state. But the UE (102) does not abort the PDN connectivity establishment procedure because it is aware that the UE is operating in the S&F mode; e.g., the UE (102) is operating on the cell which supports S&F mode and/or the network has indicated to the UE that network is in the S&F mode. The UE (102) also adjusts the retry timer of the ESM procedure with the expected time of delivery and response of the SM message considering the S&F deployment use cases; e.g., the timer value is much higher when compared to the traditional timer. On the network establishing the feeder link, the network executes the procedure with S-GW or SCEF and gets the SM context to progress the SM procedure with the UE (102). When the network interacts with the UE (e.g. on the second pass of the satellite (104)) by (re-)establishing the RRC connection or the NAS signalling connection; e.g., the single NAS procedure is executed on the multiple RRC or NAS signalling connections.

In this embodiment, the UE (102) is operating in the store and forward (S&F) mode implies that UE (102) is camped on the cell which broadcasts the support of S&F mode or the network indicates support of S&F mode to the UE (102). The UE (102) is using S&F service.

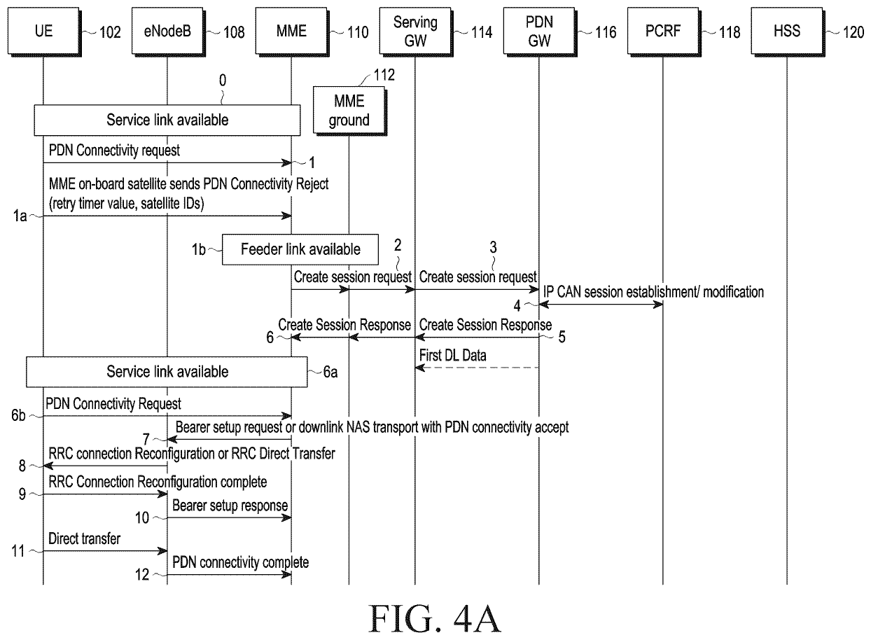

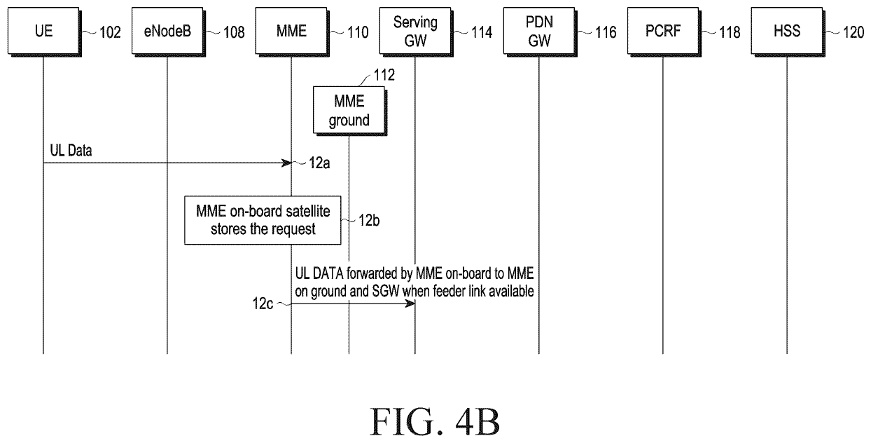

FIG. 4A and FIG. 4B depicts the PDN connectivity procedure. Consider that the service link is available between the UE (102) and the satellite (104). In operation 1, the UE (102) sends a PDN connectivity request message to the MME on board satellite via the eNodeB (108) on board the satellite. The UE (102) enters the state PROCEDURE TRANSACTION PENDING (as mentioned in section 6.5.1.2 in TS 24.301). The retry timer T3482/new timer started by UE NAS layer for this procedure is started with a value that considers the coverage information of the satellite (104), for example, the time that will be taken by the satellite to come back to UE's coverage after this pass.

In operation 1a, the MME on-board satellite stores this message from the UE (102), till the feeder link is available. At the same time, the MME on-board satellite (104) sends a PDN connectivity reject message (optionally with a new ESM cause or an indication) of partial acknowledgement to the UE (102), e.g. ESM cause or an indication indicates to the UE (102) that network has stored the information that UE (102) wants to establish the PDN connection procedure with the parameters provided in the PDN connectivity procedure, the network will execute the PDN connectivity procedure with rest of the core network elements e.g. S-GW/SCEF/IWK-SCEF etc. when they can be reached (for e.g., when the feeder link will be available)and progress the ESM procedure e.g. PDN connectivity procedure with the UE (102) after fetching the required UE subscription and ESM details from this network nodes and optionally,
a retry/wait timer value (this can either be an extended value or timer T3482, or a different timer value, and the MME provides this value based on the time it will take for another satellite to come to a geographical location over the earth, that can serve the UE again); The UE (102) is expected to retry the PDN connectivity procedure after the expiry of this timer; and
a set of satellite IDs where the UE (102) can resume this PDN connectivity procedure once UE detects cells broadcasted by such satellites.

The UE (102) does not end the procedure if the PDN connectivity reject message is received (optionally with a new ESM cause).

In operation 1b, the feeder link becomes available. In parallel, the UE (102) loses the service link with the satellite (104), and as a result, NAS signalling connection gets released and the UE (102) goes into no service. The UE (102) does not go into the usual recovery mechanism for the PDN procedure but waits for retry till timer expiry mentioned in operation 1/operation 1a. The UE (102) remains in PROCEDURE TRANSACTION PENDING state for the PDN requested.

Once the feeder link is available, the MME on-board the satellite (104) executes operations 2 to 6 as described in FIG. 3 and in section 5.10.2 of TS 23.401, via the MME on the ground. As part of these operations, the MME on board interacts with the MME on the ground, and the MME on the ground sends a create session request to the serving GW (114), and the serving GW (114) in turn sends the request to the PDN GW (116). The PDN GW (116) interacts with the PCRF (118) for IP CAN session establishment or modification. After executing these operations, the PDN GW (116) sends a create session response to the serving GW (114), and the serving GW (114) sends the same to the MME on the ground. The same is forwarded to the MME on board satellite, via the feeder link.

Similar to the solution in FIG. 3, the MME may interact with SCEF to get the SM context for this PDN connection.

In operation 6a, the satellite (104) comes back in coverage of the UE (102), e.g. the service link is available. In operation 6b, the UE (102) retries the PDN connectivity procedure based on the retry mechanism (as mentioned in operation 1a).

Once the MME receives the PDN CONNECTIVITY REQUEST message again, in operations 7 to 12, the eNodeB (108) and MME on-board satellite processes the request saved from operation 1a and execute operations 7 to 12, based on the session(s) which were created in operations 2 to 6. As part of these operations, the RABs are setup or the MME sends the PDN CONNECTIVITY ACCEPT message to the eNodeB (108). The PDN CONNECTIVITY ACCEPT/ACTIVATE DEFAULT EPS BEARER CONTEXT REQUEST message is further sent to the UE (102).

In operation 12a, the UE (102) starts sending first UL data after this operation, to the eNodeB (108) and MME on-board satellite (104). In operation 12b, the MME on-board satellite stores the UL data till the feeder link is available. In operation 12c, the MME on-board send the pended UL data to MME on ground and the S-GW/P-GW once the feeder link is available. The MME and eNodeB (108) are present on the satellite (104), and the MME-gnd is MME ground (112) which is present on the ground.

The message names ‘PDN connectivity accept’, ‘ACTIVATE DEDICATED EPS BEARER CONTEXT REQUEST’ and ‘ACTIVATE DEFAULT EPS BEARER CONTEXT REQUEST’ are used interchangeably herein. This may be any ESM message in response to PDN connectivity request sent from the UE (102).

The message names ‘PDN connectivity complete’ and ‘ACTIVATE DEFAULT EPS BEARER CONTEXT REQUEST’ are used interchangeably in this embodiment. This may be any ESM message in response to PDN connectivity request from the UE (102).

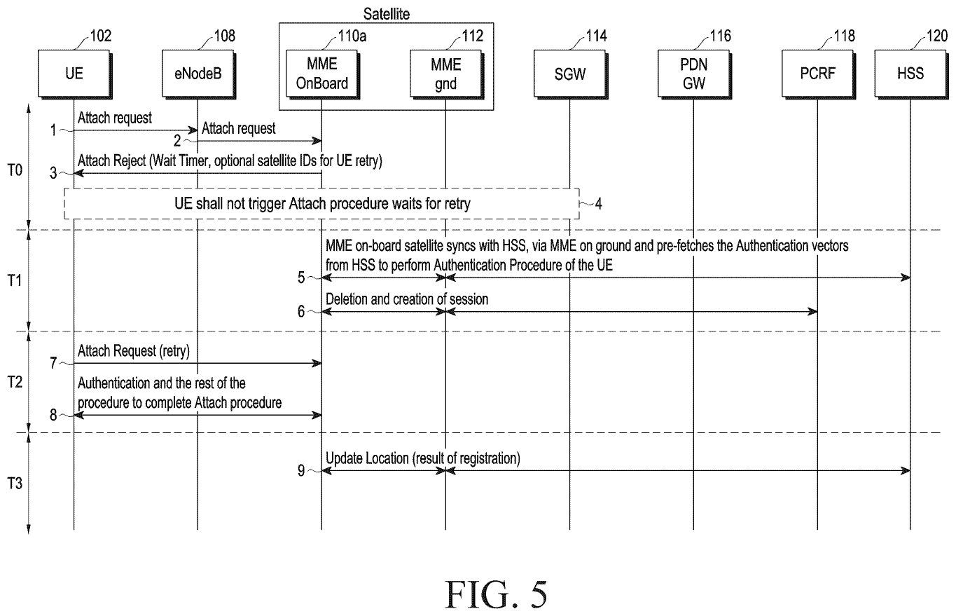

FIG. 5 depicts the Attach Procedure with PDN connectivity. The eNodeB (108), MME may be considered to be on-board the satellite (104), while the rest of the system is on the ground. The attach procedure as described in 3GPP TS 23.401 clause 5.3.2.1 are executed with below modifications:

At time T0 (e.g., when the 5G system on board satellite is serving the UE (102), and feeder link connectivity is not available):

If the UE (102) identifies that current serving cell support S&F mode and the UE (102) is allowed to use S&F, in operation 1, the UE (102) sends attach request message to network. The UE (102) may additionally include IMSI identifier even though it has GUTI to avoid potential identification procedure.

In operation 2, the ATTACH REQUEST is forwarded by the eNodeB (108) to the MME on-board the satellite (104).

In operation 3, the MME on-board sends attach reject message to the UE (102). The message may include:
A new information indicating the UE (102) that attach or TAU procedure cannot be completed because of the S&F operation and that the UE (102) may re-attempt the attach or TAU in this PLMN in a next satellite pass. This indicates to the UE (102) that the information contained in the attach or TAU request message is stored by the MME and the network will be available to the UE (102) after interaction with ground network (106).
A wait timer: Indicates to the UE (102) the time it should wait before re-attempting the attach/TAU procedure in the current or another satellite of the same PLMN.

Optionally, the list of satellite IDs (also called as monitoring list) over which the UE (102) may re-attempt the attach/TAU procedure, after the wait timer expires. The satellite IDs is based on the SIB information broadcasted by the eNodeB (108).

In operation 4, the UE (102) shall not trigger retry till wait timer is running, will wait for a retry based on mechanism mentioned in operation 3.

At time T1 (e.g., when 5G system on board satellite is connected directly or indirectly to ground station but cannot connect to the UE (102), and feeder link connectivity is available):
In operation 5, the MME on-board syncs with the HSS (120) on ground, via MME on ground, and fetches all the authentication vectors (security context) of the UE (102) from the subscription information of the UE (102) in the HSS (120). This will be needed to authenticate the UE (102) before the attach procedure may be completed. The MME on ground indicates S&F to the HSS (120) to retrieve subscription details specific to S&F (if any) and indicates that it is pre-fetching the subscription data without authenticating the UE (102).

In operation 6, the operations 7, 10, and 12 to 16 3GPP TS 23.401 clause 5.3.2.1 are executed between MME (110), SGW (114), PGW (116) and PCRF (118), e.g. deletion, update and creation of session for the PDN connectivity procedure for the Attach procedure are performed. As part of these operations, the MME (110) interacts with the SGW (114) and PGW (116) on the ground, to delete/release old sessions if required, and also create new sessions for the PDN connectivity procedure; e.g., as part of these operations, the MME on the ground sends a create session request to the serving GW (114), and the serving GW (114) sends the request to the PDN GW (116). The PDN GW (116) interacts with the PCRF (118) for IP CAN session establishment or modification. After executing these operations, the PDN GW (116) sends a create session response to the serving GW (114), and the serving GW (114) sends the same to the MME on the ground. Completion of these operations is important, as the session related information will be saved by the MME on ground, after successfully executing these operations. This information will be synced with the MME on-board the satellite (104) while the feeder link is still available. The MME on-board the satellite (104) uses the session related information to process the attach procedure which will be retried by the UE on, as mentioned in the following operations in FIG. 5; e.g. the MME executes these operations even before authenticating the UE (102) and pre-fetches the ESM information required to progress the PDN connectivity procedure at time T2 when the service link will be available with the UE (102) and ESM procedure may be progressed.

At time T2 (e.g., when the 5G system on board satellite starts serving the UE (102) again, and feeder link connectivity is not available)

In operation 7, the UE (102) performs retry for the attach procedure, based on mechanism(s) mentioned in operation 3, and sends ATTACH REQUEST message again to eNodeB (108) and MME on-board satellite.

On receiving the attach request from the UE (102) again, in operation 8, the MME on-board satellite starts processing the request. The MME also starts using the pre-fetched authentication vectors which were saved from Operation 5. This helps the MME in performing the authentication procedure, and process the attach procedure or the retry from the UE (102) (as received in operation 7). The MME executes the authentication and security procedure with the UE (102) (using the information saved from operation 5). Once the authentication procedure and the security mode procedure is successful, the system executes the remaining operations to complete attach procedure with the UE (102); e.g., the MME sends an attach accept message including the session management request message (for example, PDN connectivity accept/ACTIVATE DEFAULT EPS BEARER CONTEXT REQUEST). The MME may generate the Session Management Request message because it had prefetched the session related information from the ground network (106) (as in operation 6) when interacting with the ground core network elements; e.g., when the feeder link was available by executing the create session procedure with the S-GW or the SCEF. The MME also provides S&F policies to the UE (102). Based on subscription data available, the MME may send the reject message to the UE (102) before or after the authentication/security procedures are executed. The ESM message may be included in the attach accept message sent to the UE (102). To process the PDN connectivity request, the MME on board the satellite (104) uses the session related information which was created and saved by the MME on-board satellite after operation 6. If the contents of the ATTACH REQUEST message received between operations 1 and operation 7 by the MME on-board the satellite (104) are different, the MME on-board will consider this to be a new request, and continue to process the new ATTACH REQUEST from the UE (102). Hence, operation 8 will not be executed. Operations 3 to 7 are re-executed for the new Attach procedure. Before re-executing the operations from operation 3, optionally, the MME on-board satellite and the MME on ground will delete the saved authentication vectors and the session related information fetched by the MME on-board satellite and MME on ground, in operations 5 and 6 mentioned in the call flow. Fresh set of authentication and session related information will be created and used for the new attach procedure.

At time T3 (e.g., when 5G system on board satellite is connected to ground station but cannot connect to the UE (102), and feeder link connectivity is available):
In operation 9, the MME on-board the satellite (104) sends a update location indicating to the HSS (120) that the UE (102) is authenticated successfully or not authenticated successfully. The MME on-board the satellite (104) communicates with the HSS (120) via the MME on ground, when the feeder link is available. If the UE (102) is not authenticated successfully, the MME triggers the delete session request procedure and releases all the resources established for the PDN connection on the S-GW/P-GW/SCEF before even authenticating the UE (102).

In this embodiment, the session management request message may be an ESM dummy message, which may be sent by the UE (102) or the network included in an ESM message container information element during an attach procedure, if the UE (102) does not request for PDN connection

In this embodiment, the PDN connectivity request message is used for illustration purposes. Embodiments herein may be applied for any of the ESM messages or procedures described in the TS 24.301/TS 24.501; for example,

The procedures related to EPS bearer contexts are initiated by the network and are used for the manipulation of EPS bearer contexts:
default EPS bearer context activation;
dedicated EPS bearer context activation;
EPS bearer context modification;
Eps Bearer Context Deactivation.

This example procedure is initiated by the network or by the UE (102) and may be used for the transport of user data via the control plane:
transport of user data via the control plane procedure.

The transaction related procedures are procedures initiated by the UE (102) to request for resources, e.g., a new PDN connection or dedicated bearer resources, or to release these resources:
PDN connectivity procedure;
PDN disconnect procedure;
bearer resource allocation procedure;
bearer resource modification procedure.
This procedure is initiated by the ProSe UE-to-network relay and may be used for the manipulation of EPS bearer contexts:
   remote UE report.
When combined with the attach procedure, the PDN connectivity procedure may trigger the network to execute the following transaction related procedure:
   ESM information request procedure.
When combined with the attach procedure, if EMM-REGISTERED without PDN connection is supported by the UE (102) and the network and no PDN connectivity procedure is initiated during the attach procedure, the UE (102) or the network executes the following transaction related procedure:
   ESM dummy message procedure;
   ESM status procedure;
   notification procedure.

In yet another embodiment, if the network is operating in the S&F mode, even if the UE (102) has not indicated request for Attach without PDN Connectivity, the network shall indicate “Attach without PDN Connectivity is supported”, and the UE (102) shall not establish the PDN connection request as part of the attach procedure.

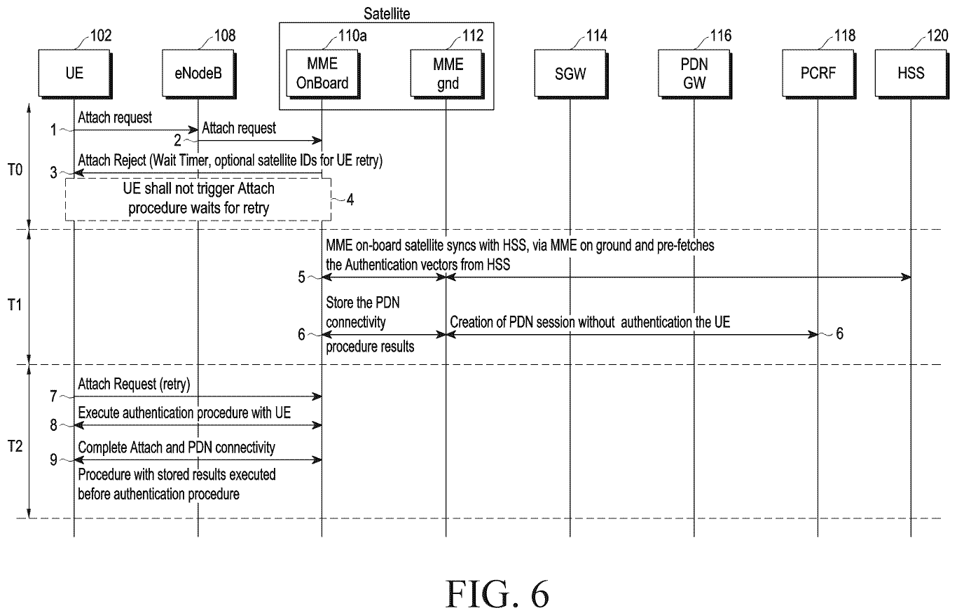

FIG. 6 depicts another attach procedure with PDN connectivity.

At time T0 (e.g. when 5G system on board satellite is serving the UE, (102) and feeder link connectivity is not available). Further, the UE (102) sends attach request message to network along with PDN connectivity request ESM message. The MME on-board sends attach reject message to the UE (102).

At time T1 (e.g., when 5G system on board satellite (104) is connected to ground station but cannot connect to the UE (102), and feeder link connectivity is available). The MME-onboard (110a) syncs with MME-ground. Without authenticating the UE (102), MME-ground executes all the procedures to establish the PDN connection procedure after interacting with the S-GW. The MME-ground synchronizes with the MME-onboards (110a) regarding the default PDN connection establishment procedure results.

At time T2 (e.g., when the 5G system on board satellite starts serving the UE (102) again (e.g. service link is established), and feeder link connectivity is not available. when the UE (102) initiates the attach procedure with a new MME-onboard again.

The MME executes the authentication and security procedure with the UE (102) (using the information saved from operation 5). Once the authentication procedure and the security mode procedure is successful, the system executes the remaining operations to complete attach procedure with the UE (102); e.g., the MME sends an attach accept message including the session management request message (for example, PDN connectivity accept/ACTIVATE DEFAULT EPS BEARER CONTEXT REQUEST).

During attach procedure, if a UE indicated control plane CIoT EPS optimisation supported in preferred network behaviour, and the UE (102) included the ESM message container, it is handled based on implementation between the MME-onboard (110a) and ground CN entities. For example, before or after the successful authentication and security mode command procedure, after the MME-onboard (110a) rejects the initial attach of the UE (see clause 4.13.9), the MME-onboard (110a) interacts with the MME-ground when the feeder link is available. The MME-ground performs the PDN connection establishment procedure (operations 12-16 of FIG. 5.3.2.1-1) with SGW. The MME-ground synchronizes with the MME-onboard (110a) regarding the default PDN connection establishment procedure results. After establishing the service link, when the UE (102) initiates the attach procedure with a new MME-onboard again, the new MME-onboard sends attach accept message after the successful establishment of the PDN connection.

In an embodiment, the term UE security context/security credential/security keys refers to at least one of (and not limited to) the authentication vector(s) (AVs), NAS counts, e.g., downlink NAS count or uplink NAS count, key set identifier (KSI), integrity and ciphering algorithms, integrity and ciphering key context, KASME or K″ASME, EPS NAS ciphering key, and EPS NAS integrity.

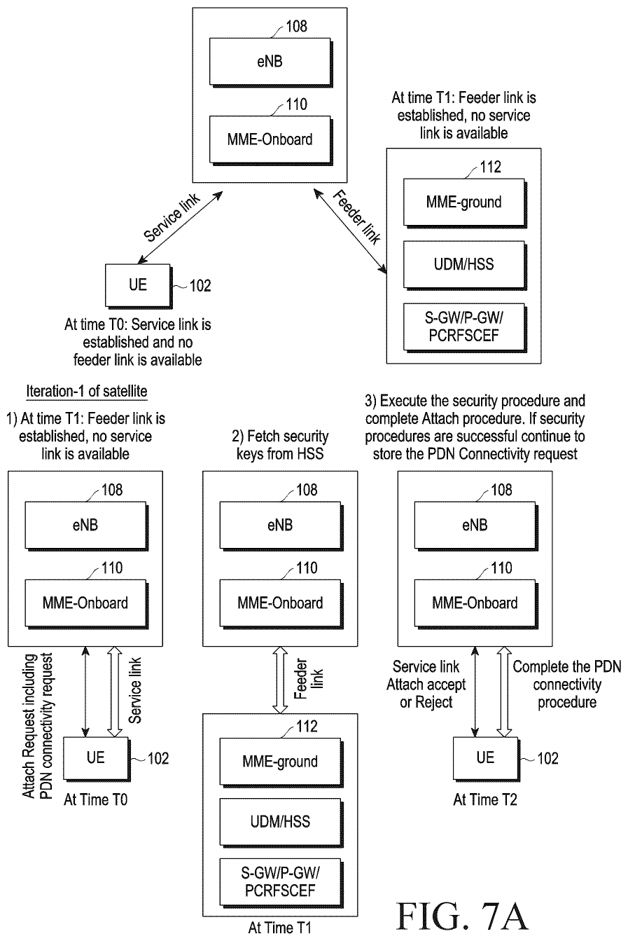

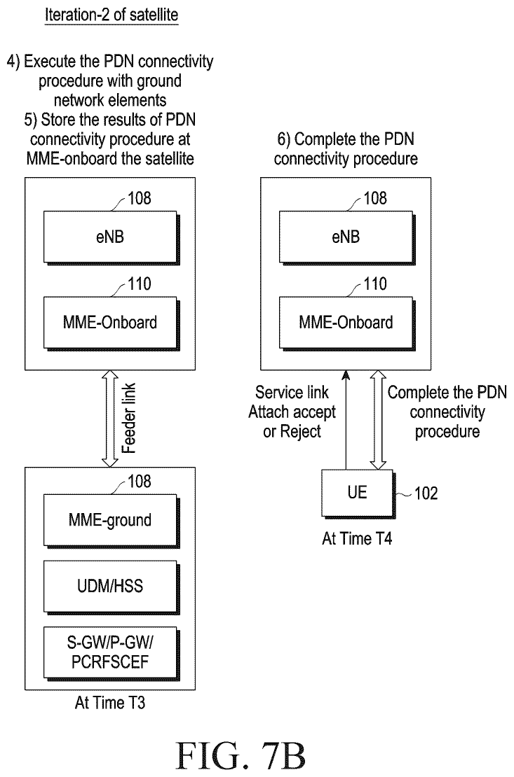

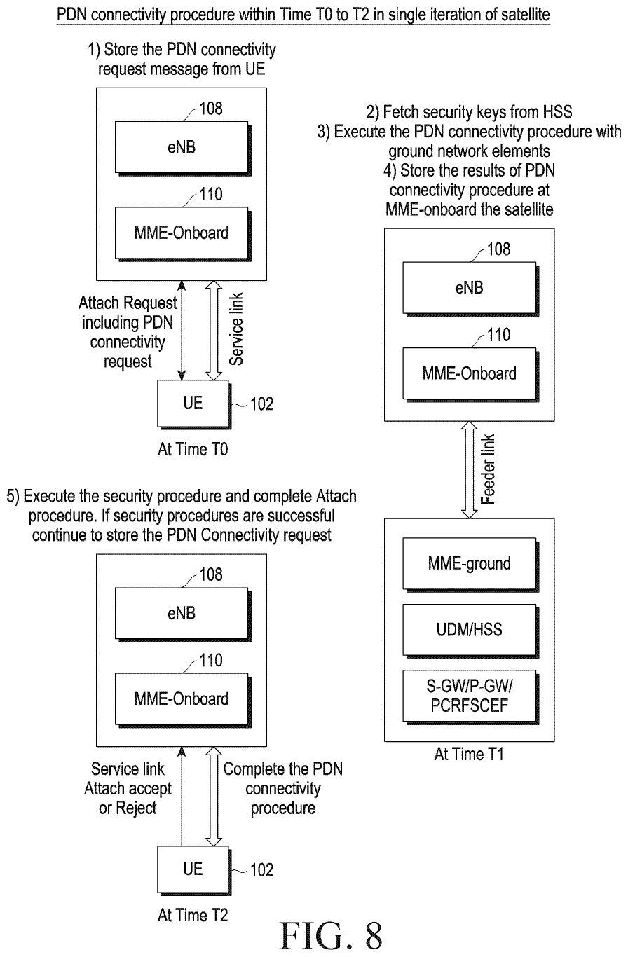

FIG. 7A to FIG. 8 are example scenario in which the satellite (104) communication network provides the PDN connectivity

As shown in FIG. 7A and FIG. 7B, In split MME architecture, the satellite (104) has MME-onboard (110a) to support S&F registration/attach procedure. Other core network entities are on the ground network (106) (e.g., example core network nodes or network functions at ground station). At time T0: service link is established and no feeder link is available. At time T0, the method may include storing the attach request and PDN connectivity request message received from the UE (102) by the MME-onboard (110a). At time T1, the method may include fetching the security keys from the HSS (120). At time T2, the method may include executing the security procedure and completing the attach procedure. If security procedures are successful continue to store the PDN connectivity request. At time T3, the method may include executing the PDN connectivity procedure with ground network elements. The method may include storing the results of PDN connectivity procedure at MME-onboard the satellite (104). At time T4, the method may include completing the PDN connectivity procedure.

FIG. 8 illustrates a PDN connectivity procedure within Time T0 to T2 in single iteration of satellite (104). At time T0, the method may include storing the PDN connectivity request message from the UE (102). At time T1, the method may include fetching the security keys from the HSS (120). The method includes executing the PDN connectivity procedure with ground network elements. The method may include storing the results of PDN connectivity procedure at MME-onboard the satellite (104). At time T2, the method may include executing the security procedure and complete attach procedure. If security procedures are successful continue to store the PDN connectivity request.

In an example, the UE (102) sends attach to network (MME-onboard) at 01:00 clock. The MME-onboard (110a) interacts with MME-ground at 06:00 clock after 5 hours. MME-ground fetches the security credentials of the UE (102) from the HSS (120). The MME-onboard (110a) also executes the PDN connectivity procedure after interacting with the S-GW before security procedures are executed for the UE (102) and syncs the results with the MME-onboard (110a). The MME-onboard (110a) again comes back in the UE serving area at 11:00 after 5 hours. MME-onboard executes the security procedures and consider the UE (102) is authenticated. The MME-onboard (110a) also executes the PDN connectivity procedures.

Thus with this new procedure of executing PDN connectivity procedure at network without authenticating the UE (102) it may take around 10 hours to execute one PDN connectivity procedure depending on the trajectory of the satellite (104) but with a single iteration which drastically reduces the time to complete the procedure and services to the UE (102).

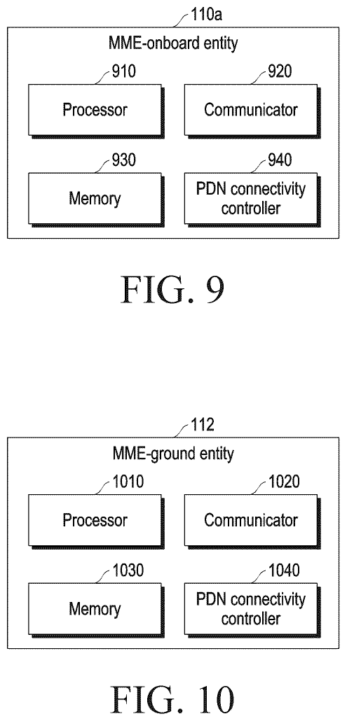

FIG. 9 shows various example hardware components of the MME-onboard entity (110a), according to the certain example embodiments. The MME-onboard entity (110a) may include at least one processor (910), a communicator (920), memory (930), and a PDN connectivity controller (940). The processor (910) is coupled directly or indirectly with the communicator (920), the memory (930), and the PDN connectivity controller (940). The PDN connectivity controller (940) may be included in the processor (910).

In an embodiment, the PDN connectivity controller (940) stores the PDN connectivity request at the first time instance on the MME-onboard entity (110a) receiving the PDN connectivity request from the UE (102). The PDN connectivity is provided during the S&F deployment mode of the satellite communication.

Further, the PDN connectivity controller (940) processes the PDN connectivity procedure based on the PDN connectivity request on the MME-onboard entity (110a) establishing the feeder link and obtains the connection with a ground core network (CN) entity. Further, the PDN connectivity controller (940) obtains the response corresponding to the PDN connectivity procedure from an MME-ground entity (112). Further, the PDN connectivity controller (940) completes the PDN connectivity procedure during the attach procedure with when the procedure is initiated by the UE (102) at a second time instance. The first time instance is different from the second time instance. The ground CN entity can be, for example, but not limited to the S-GW and the P-GW.

In another example embodiment, the PDN connectivity controller (940), comprising processing circuitry, receives the attach request message with the ESM message container from the UE (102) at the first time instance. The PDN connectivity controller (940) is configured to reject the Attach request message. The PDN connectivity controller (940) is configured to communicate with the MME-ground entity (112) at a second time instance when the feeder link is available. The PDN connectivity controller (940) is configured to execute the at least one security procedure so as to authenticate the UE (102), when the UE (102) sends the attach request message at a third time instance when service link is established. The PDN connectivity controller (940) is configured to execute the PDN connectivity procedure upon executing the at least one security procedure and providing Attach accept message to the UE (102).

The PDN Connectivity Controller (940) May Be Implemented by analog and/or digital circuits such as logic gates, integrated circuits, microprocessors, microcontrollers, memory circuits, passive electronic components, active electronic components, optical components, hardwired circuits and the like, and may optionally be driven by firmware.

The processor (910), comprising processing circuitry, may include one or a plurality of processors. The one or the plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The processor (910) may include multiple cores and is configured to execute the instructions stored in the memory (930).

Further, the processor (910) is configured to execute instructions stored in the memory (930) and to perform various processes. The communicator (920) is configured for communicating internally between internal hardware components and with external devices via one or more networks. The memory (930) also stores instructions to be executed by the processor (910). The memory (930) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (930) may, in some examples, be considered a non-transitory storage medium. The term “non-transitory” may indicate that the storage medium is not embodied in a carrier wave or a propagated signal. However, the term “non-transitory” should not be interpreted that the memory (930) is non-movable. In certain examples, a non-transitory storage medium may store data that may, over time, change (e.g., in random access memory (RAM) or cache).

Although FIG. 9 shows various hardware components of the MME-onboard entity (110a) but it is to be understood that other embodiments are not limited thereon. In other embodiments, the MME-onboard entity (110a) may include less or more number of components. Further, the labels or names of the components are used for illustrative purposes and does not limit the scope of the disclosure. One or more components may be combined together to perform the same or substantially similar function in the MME-onboard entity (110a).

FIG. 10 shows various hardware components of the MME-ground entity (112), according to the certain example embodiments. The MME-ground entity (112) may include at least one processor (1010) comprising processing circuitry, a communicator (1020), memory (1030), and a PDN connectivity controller (1040) comprising processing circuitry. The processor (1010) is coupled directly or indirectly with the communicator (1020), the memory (1030), and the PDN connectivity controller (1040). The PDN connectivity controller (1040) may be included in the processor (1010).

The PDN connectivity controller (1040) may be configured to fetch at least one security credential of a User Equipment (UE) from a server, wherein the MME-ground entity (112) communicates with the MME-onboard entity (110a). Further, the PDN connectivity controller (1040) is configured to execute a PDN connectivity procedure after interacting with a ground core network (CN) entity before at least one security procedure is executed for the UE (102).

In an embodiment, the PDN connectivity controller (1040) is configured to delete/release at least one old session for the PDN connectivity procedure. Further, the PDN connectivity controller (1040) is configured to create a new session for the PDN connectivity procedure.

In another embodiment, the PDN connectivity controller (1040) is configured to send a create session request to the S-GW, wherein the S-GW sends the create session request to the P-GW, and wherein the P-GW interacts with a policy and charging rules function (PCRF) entity (118) for at least one of: an IP CAN session establishment and an IP CAN session modification. Further, the PDN connectivity controller is configured to send a create session response to the S-GW, wherein the S-GW sends the create session response to the MME-ground entity (112), and wherein a session related information is saved by the MME-ground entity (112).

Further, the PDN connectivity controller (1040) is configured to synchronize a response of the PDN connectivity procedure with the MME-onboard entity (110a).

Further, the PDN connectivity controller (1040) synchronizes the response of the PDN connectivity procedure with the MME-onboard entity (110a) when the feeder link is still available, and the MME-ground entity (112) indicates a S&F mode to the server to retrieve a subscription details specific to the S&F mode and indicates that the MME-ground entity (112) is pre-fetching a subscription data without authenticating the UE (102).

### The PDN Connectivity Controller (1040) May Be Implemented by

analog and/or digital circuits such as logic gates, integrated circuits, microprocessors, microcontrollers, memory circuits, passive electronic components, active electronic components, optical components, hardwired circuits and the like, and may optionally be driven by firmware.

The processor (1010), comprising processing circuitry, may include one or a plurality of processors. The one or the plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The processor (1010) may include multiple cores and is configured to execute the instructions stored in the memory (1030).

Further, the processor (1010), comprising processing circuitry, may be configured to execute instructions stored in the memory (930) and to perform various processes. The communicator (1020), comprising circuitry, may be configured for communicating internally between internal hardware components and with external devices via one or more networks. The memory (1030) also stores instructions to be executed by the processor (1010). The memory (1030) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (1030) may, in some examples, be considered a non-transitory storage medium. The term “non-transitory” may indicate that the storage medium is not embodied in a carrier wave or a propagated signal. However, the term “non-transitory” should not be interpreted that the memory (1030) is non-movable. In certain examples, a non-transitory storage medium may store data that can, over time, change (e.g., in random access memory (RAM) or cache).

Although FIG. 10 shows various hardware components of the MME-ground entity (112) but it is to be understood that other embodiments are not limited thereon. In other embodiments, the MME-ground entity (112) may include less or more number of components. Further, the labels or names of the components are used for illustrative purposes and does not limit the scope of the disclosure. One or more components may be combined together to perform the same or substantially similar function in the MME-ground entity (112). The MME-ground entity (112) may comprise processing circuitry. Indeed, each “entity” herein may comprise circuitry.

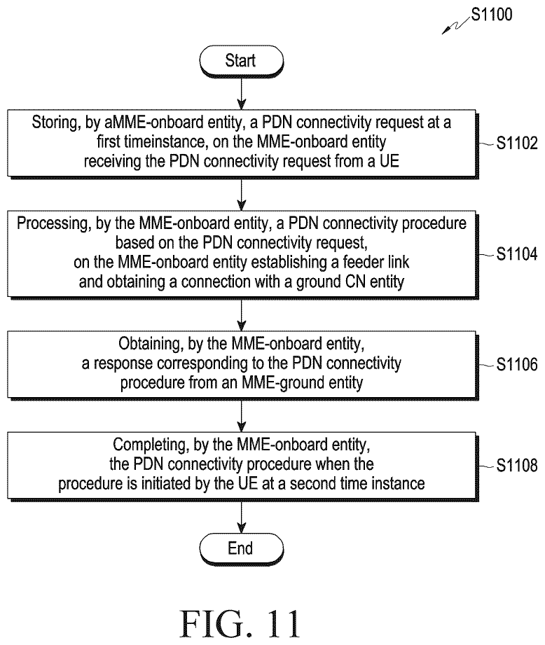

FIG. 11 is a flow chart (S1100) illustrating a method for providing the PDN connectivity in the satellite communication network by the MME-onboard entity (110a), according to the certain example embodiments. At S1102, the method may include storing, by the MME-onboard entity (110a) comprising processing circuitry, the PDN connectivity request at a first time instance, on the MME-onboard entity (110a) receiving the PDN connectivity request from the UE (102). At S1104, the method may include processing, by the MME-onboard entity (110a), the PDN connectivity procedure based on the PDN connectivity request, on the MME-onboard entity (110a) establishing a feeder link and obtaining a connection with a ground CN entity comprising processing circuitry. At S1106, the method may include obtaining, by the MME-onboard entity, (110a) the response corresponding to the PDN connectivity procedure from an MME-ground entity (112). At S1108, the method may include implementing and/or completing, by the MME-onboard entity (110a), the PDN connectivity procedure when the procedure is initiated by the UE (102) at the second time instance. “Based on” as used herein covered based at least on.

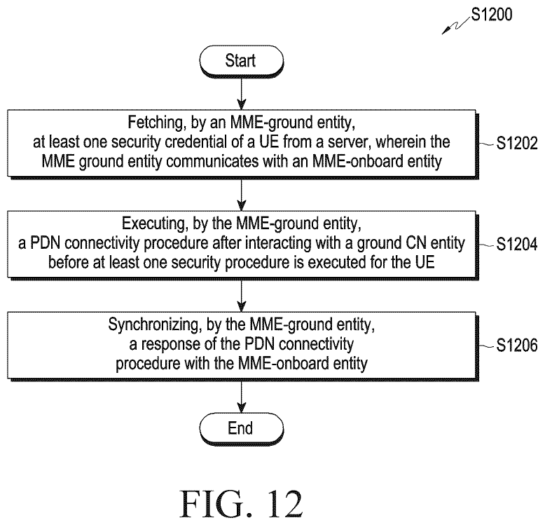

FIG. 12 is a flow chart (S1100) illustrating a method for providing a PDN connectivity in a satellite communication by the MME-ground entity (112) comprising processing circuitry, according to the certain example embodiments. At S1202, the method may include fetching, by the MME-ground entity (112), at least one security credential of the UE (102) from the server, where the MME-ground entity (112) communicates with an MME-onboard entity (110a). At S1204, the method may include executing, by the MME-ground entity (112), the PDN connectivity procedure after interacting with a ground CN entity before at least one security procedure is executed for the UE (102). At S1206, the method may include synchronizing, by the MME-ground entity (112), a response of the PDN connectivity procedure with the MME-onboard entity (110a).

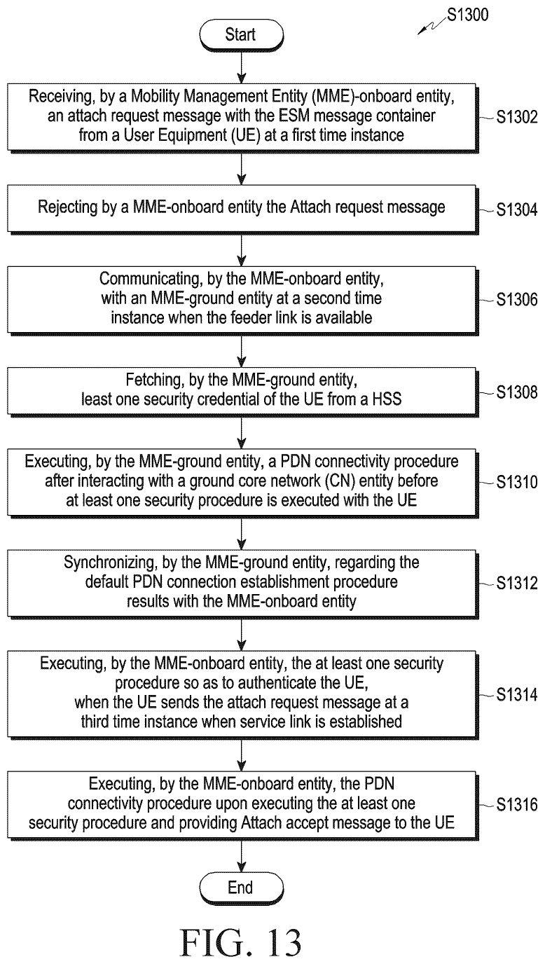

FIG. 13 is a flow chart illustrating method for providing a PDN connectivity in the satellite communication network, according to the certain example embodiments. At S1302, the method may include receiving, by a mobility management entity (MME)-onboard entity comprising processing circuitry, an attach request message with the ESM message container from a user equipment (UE) at a first time instance. At S1304, the method may include rejecting by an MME-onboard entity (110a), the attach request message. At S1306, the method may include communicating, by the MME-onboard entity (110a), with an MME-ground entity (112) at a second time instance when the feeder link is available. At S1308, the method may include fetching, by the MME-ground entity (112), at least one security credential of the UE (102) from the HSS (120).

At S1310, the method may include executing, by the MME-ground entity (112), a PDN connectivity procedure after interacting with a ground core network (CN) entity before at least one security procedure is executed with the UE (102). At S1312, the method may include synchronizing, by the MME-ground entity (112), regarding the default PDN connection establishment procedure results with the MME-onboard entity (110a). At S1314, the method include executing, by the MME-onboard entity (110a), the at least one security procedure so as to authenticate the UE (102), when the UE (102) sends the attach request message at a third time instance when service link is established. At S1316, the method may include executing, by the MME-onboard entity (110a), the PDN connectivity procedure upon executing the at least one security procedure and providing attach accept message to the UE (102).

The embodiments disclosed herein can be implemented through at least one software program running on at least one hardware device and performing network management functions to control the network elements. The elements may include blocks which can be at least one of a hardware device, or a combination of hardware device and software module.

The embodiments disclosed herein describe methods and systems for providing PDN connectivity in S&F in wireless communication networks. Therefore, it is understood that the scope of the protection is extended to such a program and in addition to a computer readable means having a message therein, such computer readable storage means contain program code means for implementation of one or more operations of the method, when the program runs on a server or mobile device or any suitable programmable device. The method is implemented in at least one example embodiment through or together with a software program written in e.g., very high speed integrated circuit hardware description language (VHDL) another programming language, or implemented by one or more VHDL or several software modules being executed on at least one hardware device. The hardware device can be any kind of portable device that can be programmed. The device may also include means which could be e.g., hardware means like e.g., an ASIC, or a combination of hardware and software means, e.g. an ASIC and an FPGA, or at least one microprocessor and at least one memory with software modules located therein. The method embodiments described herein could be implemented partly in hardware and partly in software. Alternatively, the disclosure may be implemented on different hardware devices, e.g., using a plurality of CPUs.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of embodiments, those skilled in the art will recognize that the embodiments herein can be practised with modification within the scope of the embodiments as described herein.

What is claimed is:

1. A method for providing packet data network (PDN) connectivity in a satellite communication network, the method comprising:
receiving, by a mobility management entity (MME)-onboard entity, a PDN connectivity request from a user equipment (UE) and storing the PDN connectivity request at a first time instance;
establishing, by the MME-onboard entity, a feeder link, obtaining a connection with a ground core network (CN) entity, and processing a PDN connectivity procedure based on the PDN connectivity request;
obtaining, by the MME-onboard entity, a response corresponding to the PDN connectivity procedure from an MME-ground entity; and
implementing, by the MME-onboard entity, the PDN connectivity procedure based on the PDN connectivity procedure being initiated by the UE at a second time instance.

2. The method as claimed in claim 1, wherein the PDN connectivity is provided during a store and forward (S&F) deployment mode of a satellite communication.

3. The method as claimed in claim 1, wherein the ground CN entity comprises at least one of: a serving gateway (S-GW) or a PDN gateway (P-GW).

4. The method as claimed in claim 1, wherein the first time instance is different from the second time instance.

5. A method for providing a packet data network (PDN) connectivity in a satellite communication network, the method comprising:
fetching, by a mobility management entity (MME)-ground entity, at least one security credential of a user equipment (UE) from a server, wherein the MME-ground entity communicates with an MME-onboard entity;
executing, by the MME-ground entity, a PDN connectivity procedure after interacting with a ground core network (CN) entity before at least one security procedure is executed for the UE; and
synchronizing, by the MME-ground entity, a response of the PDN connectivity procedure with the MME-onboard entity.

6. The method as claimed in claim 5, wherein executing, by the MME-ground entity, the PDN connectivity procedure after interacting with the ground CN entity comprises:
deleting, by the MME-ground entity, at least one old session for the PDN connectivity procedure; and
creating, by the MME-ground entity, a new session for the PDN connectivity procedure.

7. The method as claimed in claim 5, wherein executing, by the MME-ground entity, the PDN connectivity procedure after interacting with the ground CN entity comprises:
sending, by the MME-ground entity, a create session request to a serving gateway (S-GW), wherein the S-GW sends the create session request to a PDN gateway (P-GW), and wherein the P-GW interacts with a policy and charging rules function (PCRF) entity for at least one of: an internet protocol (IP) connectivity access network (CAN) session establishment or an IP CAN session modification,
wherein a create session response is sent to the S-GW by the P-GW, and wherein the create session response is sent to the MME-ground entity by the S-GW, and
wherein a session related information is saved by the MME-ground entity.

8. The method as claimed in claim 5, wherein the MME-ground entity synchronizes the response of the PDN connectivity procedure with the MME-onboard entity based on a feeder link being available.

9. The method as claimed in claim 5, wherein the MME-ground entity indicates a store and forward (S&F) mode to the server to retrieve a subscription details specific to the S&F mode and indicates that the MME-ground entity is pre-fetching a subscription data without authenticating the UE.

10. The method as claimed in claim 5, wherein the ground CN entity comprises at least one of: a serving gateway (S-GW), or a PDN gateway (P-GW), and wherein the server is a home subscriber server (HSS).

11. A satellite communication network, comprising:
a mobility management entity (MME)-onboard entity comprising first memory storing first instructions, and at least one first processor comprising processing circuitry and coupled with the first memory,
wherein the first instructions, when executed by the at least one first processor, cause the MME-onboard entity to:
receive a packet data network (PDN) connectivity request from a user equipment (UE) and store the PDN connectivity request at a first time instance;
establish a feeder link, obtain a connection with a ground core network (CN) entity and process a PDN connectivity procedure based on the PDN connectivity request;
obtain a response corresponding to the PDN connectivity procedure from an MME-ground entity; and
implement the PDN connectivity procedure based on the PDN connectivity procedure being initiated by the UE at a second time instance.

12. The satellite communication network as claimed in claim 11, wherein the PDN connectivity is provided during a store and forward (S&F) deployment mode of a satellite communication.

13. The satellite communication network as claimed in claim 11, wherein the ground CN entity comprises at least one of: a serving gateway (S-GW) or a PDN gateway (P-GW).

14. The satellite communication network as claimed in claim 11, wherein the first time instance is different from the second time instance.

15. The satellite communication network as claimed in claim 11, further comprising:
a MME-ground entity comprising second memory storing second instructions, and at least one second processor comprising processing circuitry and coupled with the second memory,
wherein the second instructions, when executed by the at least one second processor, cause the MME-ground entity to:
fetch at least one security credential of a user equipment (UE) from a server, wherein the MME-ground entity is configured to communicate with an MME-onboard entity;
execute a PDN connectivity procedure after interacting with a ground core network (CN) entity before at least one security procedure is executed for the UE; and
synchronize a response of the PDN connectivity procedure with the MME-onboard entity.

16. The satellite communication network as claimed in claim 15, wherein, to execute the PDN connectivity procedure after interacting with the ground CN entity, the second instructions, when executed by the at least one second processor, cause the MME-ground entity to:
delete at least one old session for the PDN connectivity procedure; and
create a new session for the PDN connectivity procedure.

17. The satellite communication network as claimed in claim 15, wherein, to execute the PDN connectivity procedure after interacting with the ground CN entity, the second instructions, when executed by the at least one second processor, cause the MME-ground entity to:
send a create session request to a serving gateway (S-GW),
wherein the S-GW sends the create session request to a PDN gateway (P-GW),
wherein the P-GW interacts with a policy and charging rules function (PCRF) entity for at least one of: an internet protocol (IP) connectivity access network (CAN) session establishment or an IP CAN session modification,
wherein a create session response is sent to the S-GW by the P-GW, wherein the create session response is sent to the MME-ground entity by the S-GW, and
wherein a session related information is saved by the MME-ground entity.

18. The satellite communication network as claimed in claim 15, wherein the second instructions, when executed by the at least one second processor, cause the MME-ground entity to synchronize the response of the PDN connectivity procedure with the MME-onboard entity based on a feeder link being available.

19. The satellite communication network as claimed in claim 15, wherein the second instructions, when executed by the at least one second processor, cause the MME-ground entity to indicate a store and forward (S&F) mode to the server to retrieve a subscription details specific to the S&F mode and indicate that the MME-ground entity is pre-fetching a subscription data without authenticating the UE.

20. The satellite communication network as claimed in claim 15, wherein the ground CN entity comprises at least one of: a serving gateway (S-GW), or a PDN gateway (P-GW), and
wherein the server is a home subscriber server (HSS).
